(19) United States
(12) Patent Application Publication
(10) Pub. No.: US 2024/0166069 A1
(43) Pub. Date: May 23, 2024

(54) POWER DISTRIBUTION MODULES FOR ELECTRIC DRIVETRAINS

(71) Applicant: Hexagon Purus North America Holdings Inc., Costa Mesa, CA (US)

(72) Inventors: Ethan J. McKibben, Kelowna (CA); Eric M. Coupal-Sikes, Kelowna (CA); Todd F. Sloan, Kelowna (CA); Chris Forsberg, Kelowna (CA); Landon Tyerman, Kelowna (CA); Ryan J. Moloney, Kelowna (CA)

(21) Appl. No.: 18/425,931

(22) Filed: Jan. 29, 2024

Related U.S. Application Data
(63) Continuation of application No. PCT/US2022/040914, filed on Aug. 19, 2022.
(60) Provisional application No. 63/260,601, filed on Aug. 26, 2021.
(60) Provisional application No. 63/237,468, filed on Aug. 26, 2021.

(51) Int. Cl. B60L 53/60; B60L 53/16; B60R 16/023

(52) U.S. Cl. CPC B60L 53/60; B60L 53/16; B60R 16/0238

(57) ABSTRACT

A power distribution assembly includes a mounting system and a power distribution unit. The mounting system has a frame rail interface disposed along lateral sides of the power distribution assembly. The power distribution unit has a housing and a cable junction disposed on an exterior of the housing. The housing has an upper portion coupled with the frame rail interface and a lower portion disposed below the mounting system. The power distribution unit has one or more fuses, a contactor, and a charge circuit disposed in the housing. The lower portion of the housing has an access panel accessible from beneath a vehicle to which the power distribution assembly is coupled. Such access may be gained by removing a debris deflector and the housing. The power distribution assembly can be electrically coupled with a battery assembly and a charge inlet assembly, which can be coupled to the battery assembly.

### INCORPORATION BY REFERENCE TO ANY PRIORITY APPLICATIONS

This application is a continuation of PCT/US2022/040914, filed Aug. 19, 2022, which claims the benefit under 35 U.S.C. § 119(e) to U.S. Provisional Application No. 63/260,601, filed Aug. 26, 2021, and U.S. Provisional Application No. 63/237,468, filed Aug. 26, 2021, the entire disclosures of which are hereby incorporated by reference in their entirety. Any and all applications for which a foreign or domestic priority claim is identified in the Application Data Sheet as filed with the present application are hereby incorporated by reference under 37 C.F.R. § 1.57.

### BACKGROUND

### Field of the Invention

This application is directed to modules for controlling electric drivetrains for vehicles, in particular for trucks and other utility vehicles of various types.

### Description of the Related Art

Electric vehicles have become more and more popular in recent years. This is particularly true among passenger vehicles. The use of electric motors and batteries to propel heavy and medium duty utility vehicles has been much less prevalent. Equipping utility vehicles such as these with well-designed electric drivetrains presents unique complexities.

### SUMMARY

There is a need for improved modules that enable mounting a variety of power electronics components in compact arrangements on heavy and medium duty utility vehicles. Such modules include systems that are adapted to mount directly to stock vehicle assemblies, e.g., to stock chassis with longitudinal frame rails. Preferably such modules take up a small amount of frame rail length while at the same time facilitating simultaneous coupling of two, three or more than three core electric drivetrain control components. In various configurations, a subset of electrical components can be disposed in a separate assembly and mounted separately from other components to enable the subset of components to be located adjacent to an e-axle, other electric motor, or other load, to minimize resistance losses.

In one embodiment a power distribution unit is provided that includes a housing, a cable junction, one or more fuses, one or more contactors, and a charging circuit. The cable junction is disposed on an exterior of the housing. The fuse(s) is or are disposed in the housing and is or are configured to interrupt current flow through the power distribution unit. The contactor(s) is or are disposed in the housing and is configured to interrupt current flow from the power distribution unit to a load. The charge circuit is disposed in the housing and is configured to direct current from a DC power source to a vehicle battery assembly. The charge circuit has one or more fuses and one or more contactors configured to interrupt current flow from the DC power source to the vehicle battery assembly.

In one variation, the charge circuit is a first charge circuit and the power distribution unit also has a second charge circuit disposed in the housing. The second charge circuit is configured to receive current from an AC power source. The second charge circuit is configured to convert the AC power source to DC and then direct the current to a vehicle battery.

In one variation, a power distribution assembly is provided that includes a power distribution unit and a mounting system. The mounting system includes a frame rail interface disposed along lateral sides of the power distribution assembly, an upper tray, and a cable strain relief management module. In some applications, the mounting system advantageously also includes one or more vibration isolators to reduce, minimize or eliminate frame twist and/or on-road vibration. The cable strain relief management module is disposed on a portion of the power distribution assembly at which high voltage or other cables are coupled, e.g., to a portion with current cable junctions, such as a forward facing side of the power distribution assembly. In some embodiments the current cable junctions are on another side, such as a lateral side, a rearward side, a bottom side, and/or a top side and the cable strain relief module can be disposed on such side or sides in these other embodiments. A clamp or other strain relief component of the cable strain relief module can be aligned with the cable junction.

The mounting system can include a number of additional features. In one embodiment, the frame rail interface has a first bracket and a second bracket. The first bracket has a vertical portion configured to engage an inwardly facing surface of a first frame rail, which can be a C-shaped frame rail, and a horizontal portion configured to be disposed over a transverse surface of the first (e.g., C-shaped) frame rail. The second bracket is configured to couple with a second frame rail, which can be a second C-shaped frame rail, opposite the first (e.g., C-shaped) frame rail. The second bracket can have a vertical portion configured to engage an inwardly facing surface of the second C-shaped frame rail and a horizontal portion configured to be disposed over a transverse surface of the second C-shaped frame rail. In one embodiment, the upper tray is supported on a first lateral portion by the first bracket and on a second lateral portion by the second bracket.

The power distribution assembly can include a charge circuit supported on a lower side of the upper tray above the housing of the power distribution unit. The charge circuit can be configured to receive current from an AC power source and to direct the current to a vehicle battery to charge the vehicle battery. In various embodiments, the AC power source current is directed from the charge circuit to a battery assembly via the power distribution assembly, e.g., via a power distribution unit disposed in the power distribution assembly.

In some applications, the power distribution assembly is configured to be mounted at or below frame rails of a vehicle assembly. The power distribution assembly can be configured to protect electric components thereof from rocks and other road debris. The power distribution assembly can include a debris deflector coupled with the frame rail interface along at least one of the lateral sides of the power distribution assembly. The debris deflector can enclose a bottom side and lateral sides of the power distribution unit. The debris deflector can leave unobstructed access for power cables to the cable junction.

In one configuration the cable junction is on a forward facing side of the power distribution assembly. The debris deflector can be open on a forward side thereof such that high voltage conveyance can extend horizontally straight into enclosed space within the debris deflector.

The power distribution assembly can provide a compact system configured to be mounted at a single location along frame rails of a vehicle assembly. In one application with a short wheelbase, the power distribution assembly can be mounted close to the rear wheels providing for a relatively short span of electrical conveyance between the power distribution assembly and an electric motor coupled with the rear wheels. In another application, the power distribution assembly can be mounted close to an electric motor disposed centrally in a vehicle assembly allowing for a relatively short span of electrical conveyance between the power distribution assembly and the centrally mounted electric motor coupled with the rear wheels via a longitudinal drive shaft. In one single frame rail mount variation, a traction inverter is coupled with an upper side of the upper tray. The traction inverter is configured to be coupled to the cable junction to receive power from the power distribution unit. The traction inverter is configured to be coupled with an electric motor to deliver current to the electric motor to apply torque to a vehicle axle. The power distribution assembly also includes a powertrain control module configured to control the torque and speed of an electric motor, such as an axle drive assembly, coupled with the power distribution assembly. These arrangements allow the frame rail length occupied by the power distribution assembly to be relatively small, making the power distribution assembly well suited for vehicle assemblies with shorter wheelbases and also leaving more of the frame rail open for other components, such as second and additional battery packs, fuel cells and other components of an electric drivetrain system or specialty vehicle bodies.

In some cases, a longer span of electrical conveyance would be required to couple a power distribution assembly to an electric motor. Such cases would benefit from dispersing some components of a power distribution system along a chassis of a vehicle. A power distribution system can include any of the foregoing power distribution assemblies, wherein the mounting system thereof comprises a first mounting system. The power distribution system also includes a second mounting system having a second frame rail interface, a second upper tray, and a second cable management module. A traction inverter is coupled with an upper side of the second upper tray. The traction inverter is configured to be coupled to the cable junction by way of the cable management module of the first mounting system to receive power from the power distribution unit and to be coupled with an electric motor to deliver current to the electric motor to apply torque to a vehicle axle. The power distribution system can also include a powertrain control module coupled with the second upper tray. The powertrain control module can be configured to regulate the flow of current through the traction inverter to an electric motor coupled with the power distribution system.

In one dispersed power distribution system, a first debris deflector can be coupled with the first mounting system and a second debris deflector can be coupled with the second mounting system. The second debris deflector has a forward deflector panel and a rearward deflector panel. The first debris deflector can enclose a bottom side and lateral sides of the power distribution unit. The first debris deflector can leave unobstructed access for power cables to the cable junction.

In one variation of the power distribution system, a forward debris deflector is coupled with the first mounting system and a rearward debris deflector is coupled with the second mounting system. The forward debris deflector provides a first ground clearance and the rearward debris deflector provides a second ground clearance greater than the first ground clearance. Thus a dispersed power distribution system can enable a shorter electrical conveyance between a traction inverter and an electric motor and also provide improved ground clearance close to the rear wheels.

In one variation a vehicle assembly includes the power distribution system and a battery assembly. The battery assembly includes a battery housing and a charge inlet assembly. The battery housing is configured to house one or more battery units. The charge inlet assembly is coupled to the battery housing. The charge inlet assembly includes a charge inlet configured to receive electrical charge from a charge plug. A charge inlet housing coupled to the battery housing. The charge inlet housing is disposed on a forward facing side of the battery housing.

In one variation, the charge inlet assembly further comprises a door configured to cover and protect the charge inlet.

In one variation, the vehicle assembly further comprises a step assembly having one or more steps and configured to span a longitudinal length of the charge inlet housing and the battery housing.

In one variation, the step assembly includes an aperture located on a face of the step assembly corresponding to a receptacle of the charge inlet assembly.

In one variation, the aperture of the step assembly is aligned with a door hinge of the electric vehicle.

In one variation, the step assembly includes one or more impact features configured to protect one or both of the battery housing and the charge inlet assembly from impact.

In one variation, the charge inlet assembly further comprises one or more charge status lights configured to indicate a charge status of the one or more battery units.

In one embodiment a power distribution assembly includes a mounting system and a power distribution unit. The mounting system has a frame rail interface disposed along lateral sides of the power distribution assembly. The power distribution unit has a housing and a cable junction disposed on an exterior of the housing. The housing has an upper portion coupled with the frame rail interface and a lower portion disposed below the mounting system. The lower portion has an access panel. The power distribution unit also includes several components within the housing. For example, one or more fuses are disposed in the housing. The fuses are configured to interrupt current flow through the power distribution unit. The power distribution unit includes one or more contactors and a charge circuit disposed in the housing. The contactor(s) is or are configured to interrupt current flow from the power distribution unit to a load. The charge circuit is configured to direct current from a DC power source to a vehicle battery assembly. The charge circuit has one or more fuses and/or one or more contactors configured to interrupt current flow from the DC power source to the vehicle battery assembly.

In another embodiment, a vehicle assembly is provided. The vehicle assembly includes a vehicle chassis, a battery pack, and a power distribution assembly. The vehicle chassis has a longitudinal frame rail that has a concave cross-section oriented toward a central vertical plane of the vehicle chassis such that a horizontal surface extends inwardly from a vertical surface of the longitudinal frame rail. The battery pack is coupled with the vehicle chassis and is disposed at least partially below the longitudinal frame rail. The power distribution assembly includes a mounting system and a power distribution unit. The mounting system has a bracket having a vertical portion overlapping the vertical surface of the longitudinal frame rail and a horizontal portion disposed over or hanging above, and in some embodiments resting on, the horizontal surface of the longitudinal frame rail. The vertical surface and the horizontal surface comprises a clearance opening. The power distribution unit is coupled with the mounting system. The power distribution unit has a cable junction, one or more fuses, one or more contactors, and a charge circuit. The cable junction faces and is disposed adjacent to a rear surface of the battery pack. The one or more fuses are configured to interrupt current flow through the power distribution unit. The contactor(s) is or are configured to interrupt current flow from the power distribution unit to a load. The charge circuit is configured to direct current from a DC power source to the battery pack. The charge circuit comprises one or more fuses and one or more contactors configured to interrupt current flow from the DC power source to the battery pack. The mounting system also includes a fastener disposed around the longitudinal frame rail. The fastener passes through the clearance opening to enclose the bracket and the longitudinal frame rail.

In one variation, the battery pack further comprises a charge inlet assembly coupled to a battery pack housing. The charge inlet assembly having a charge inlet configured to receive electrical charge plug.

In one variation, the charge inlet assembly is disposed between a forward facing side of the battery assembly and a front of the vehicle assembly.

In one variation, the charge inlet assembly further comprises a door configured to cover and protect the charge inlet.

In one variation, the battery pack further comprises a step assembly having one or more steps and configured to span at least a portion of a lateral edge of a charge inlet housing and the battery pack housing.

### BRIEF DESCRIPTION OF THE DRAWINGS

Features of the invention can be better understood from the following detailed description when read in conjunction with the accompanying schematic drawings, which are for illustrative purposes only. The drawings include the following figures:

FIG. 1 is a side view of a first vehicle assembly including a power distribution assembly;

FIG. 2 is a schematic view of an electric drivetrain including one embodiment of a power distribution assembly;

FIG. 3 is a perspective view of one embodiment of the power distribution assembly shown in FIG. 1;

FIGS. 4-4A is a perspective view of a power distribution unit of the power distribution assembly of FIG. 3, the power distribution unit being coupled with a portion of a mounting system;

FIGS. 5 and 5A are perspective views of additional power distribution components of the power distribution assembly of FIG. 3 coupled with a portion of a mounting system;

FIGS. 6-6B are perspective and exploded views of a mounting system of the power distribution assembly of FIG. 3;

FIG. 6C is a perspective view of one embodiment of a rock guard configured to protect one or more components of the power distribution assembly of FIG. 3;

FIGS. 7 and 7A show structures enabling connection of the power distribution assembly of FIG. 3 to frame rails of a vehicle assembly;

FIG. 8 is a side view of a second vehicle assembly including a dispersed power distribution system including a plurality of power distribution assemblies;

FIG. 9 is a schematic view an electric drivetrain including one embodiment of the dispersed power distribution system in FIG. 8;

FIG. 10 is a perspective view of one embodiment of a dispersed power distribution system;

FIG. 11-13 are perspective, side and exploded views of one embodiment of an enhanced ground clearance mounting system for a power distribution assembly of the dispersed power distribution system of FIG. 10;

FIG. 14 is a perspective view of a battery housing attached to a charge inlet assembly;

FIG. 14A shows a step assembly separated from a lateral portion of a battery assembly;

FIG. 14B is an exploded view of one example of a step assembly;

FIG. 14C is a perspective view illustrating a multi-point load spreading member for supporting a step assembly to a housing of a battery assembly;

FIG. 14D illustrates a housing side of the multi-point load spreading member of FIG. 14C;

FIGS. 15A-15B illustrate the charge inlet assembly and the charge inlet assembly disposed adjacent to and/or coupled to the step assembly;

FIGS. 16A-16B illustrate the charge inlet with a door closed and the door open; and

FIG. 17 illustrates a perspective view of the charge inlet assembly coupled with a forward or rearward side of a battery assembly.

### DETAILED DESCRIPTION

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein. Each and every feature described herein, and each and every combination of two or more of such features, is included within the scope of the present invention provided that the features included in such a combination are not mutually inconsistent.

This application discloses advantageous power electronics modules that facilitate equipping heavy and medium duty utility vehicles with electric powertrain systems. Such modules can mount directly to stock vehicles reducing the need to manufacture or customize specific chassis or other subassemblies of the vehicle for electric drivetrain use. Such modules can be configured to occupy a small amount of frame rail length such that a variety of vehicles can be combined therewith. For shorter wheelbase vehicles and longer wheelbase vehicles with centrally mounted electric motors, the power electronics modules disclosed herein can allow all or substantially all power electronics electrically between one or more battery modules and one or more loads, e.g., e-axles or electric motors, to be supported by a single frame assembly. For longer wheelbase vehicles with e-axles or electric motors disposed adjacent to the rear wheels, all or substantially all power electronics electrically between one or more battery modules and one or more loads, e.g., e-axles or electric motors, can be supported in two, e.g., in only two, modules each of such modules to be supported by a single frame assembly.

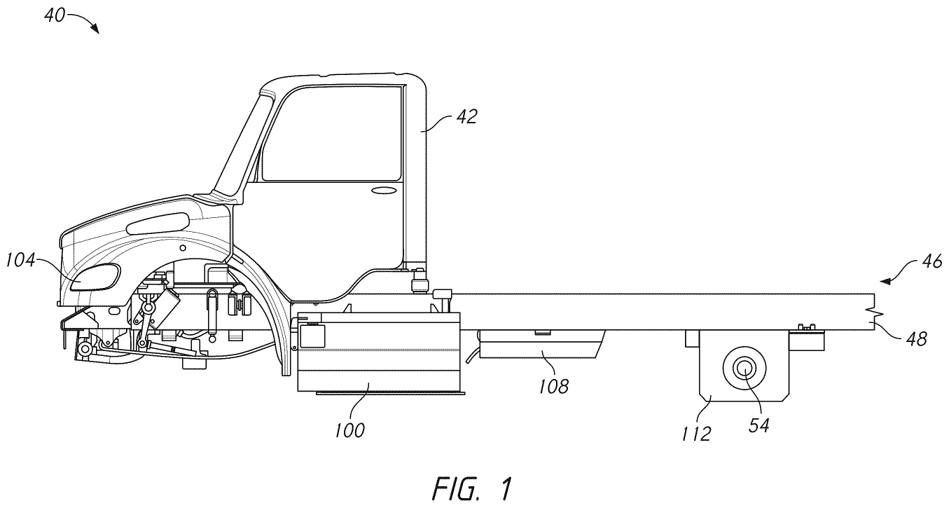

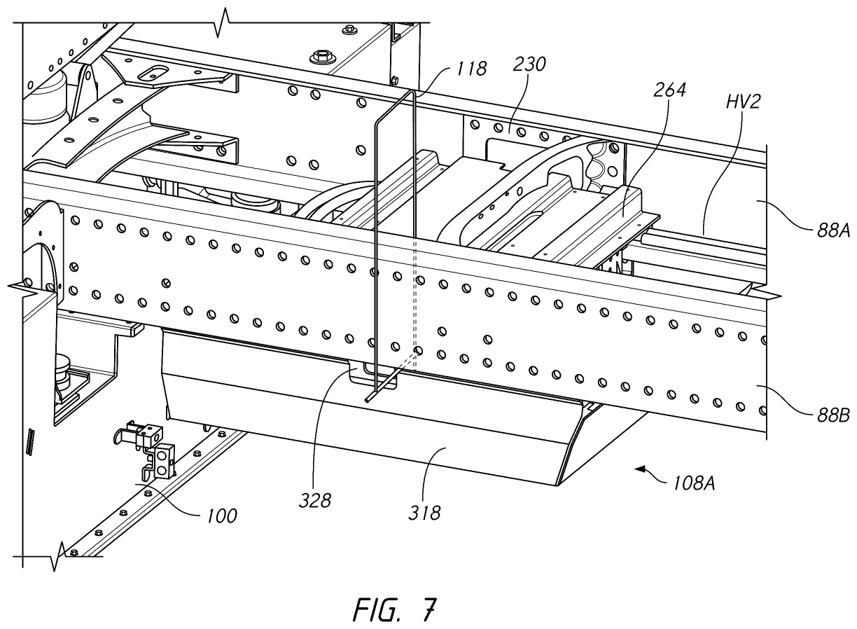

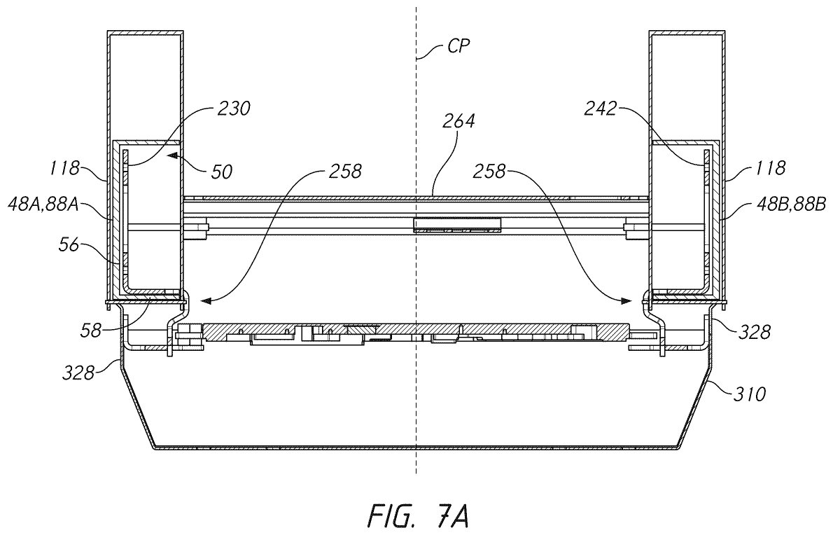

FIGS. 1-6C and 7A show examples of an electric drivetrain system for a vehicle assembly 40 having a relatively short wheel-base and components for the same. The vehicle assembly 40 that includes a cab 42 and a chassis or frame assembly 46 including frame rails 48. As seen in FIG. 7A the vehicle assembly 40 includes a first frame rail 48A and a second frame rail 48B in one embodiment. The frame rails 48A, 48B can be C-shaped in some embodiments. The frame rail 48A can have a concave cross-section 50 facing a central vertical plane CP of the vehicle assembly 40. The frame rail 48A can have a vertical surface 56 extending substantially parallel to the central vertical plane CP and a horizontal surface 58 or other transverse surface extending toward the central vertical plane CP from the vertical surface 56. The frame rail 48B can have the same configuration but disposed on the opposite side of the central vertical plane CP from the frame rail 48A.

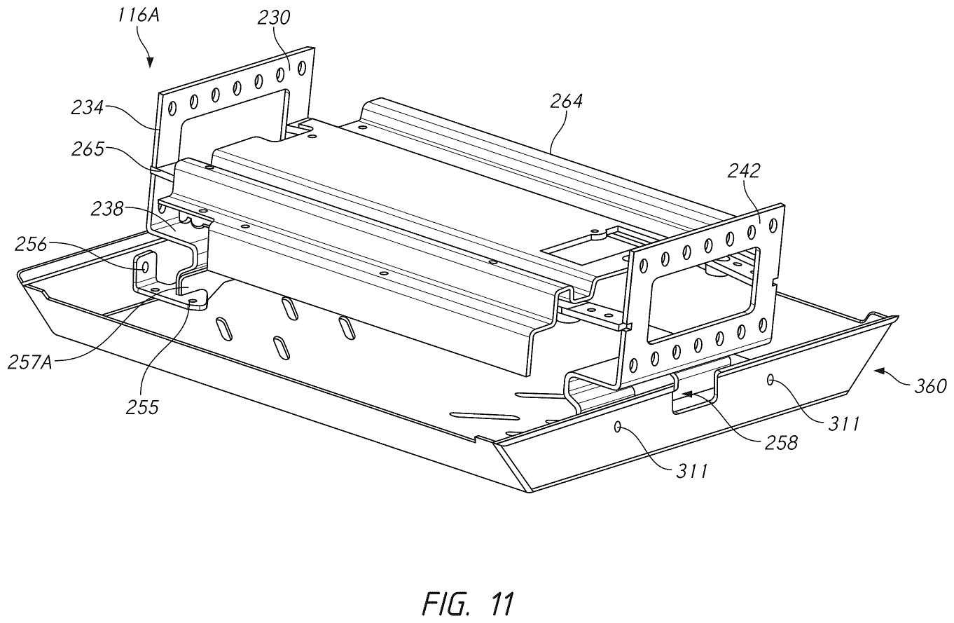

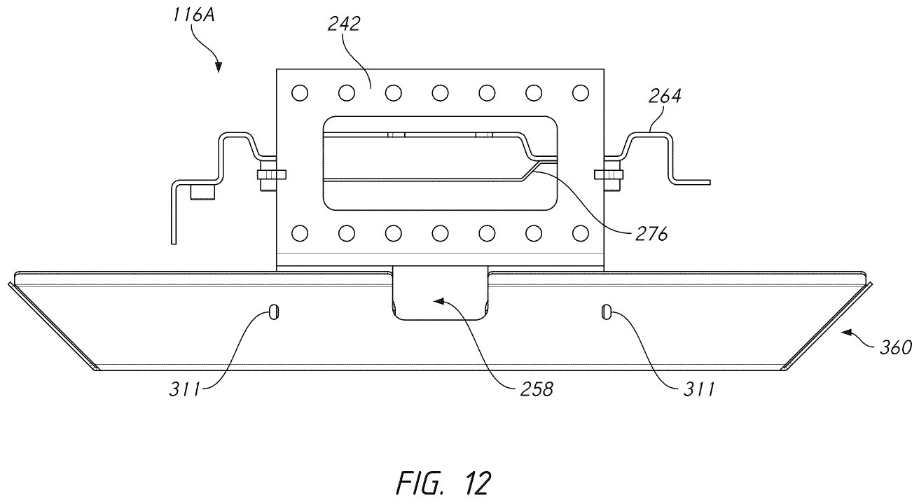

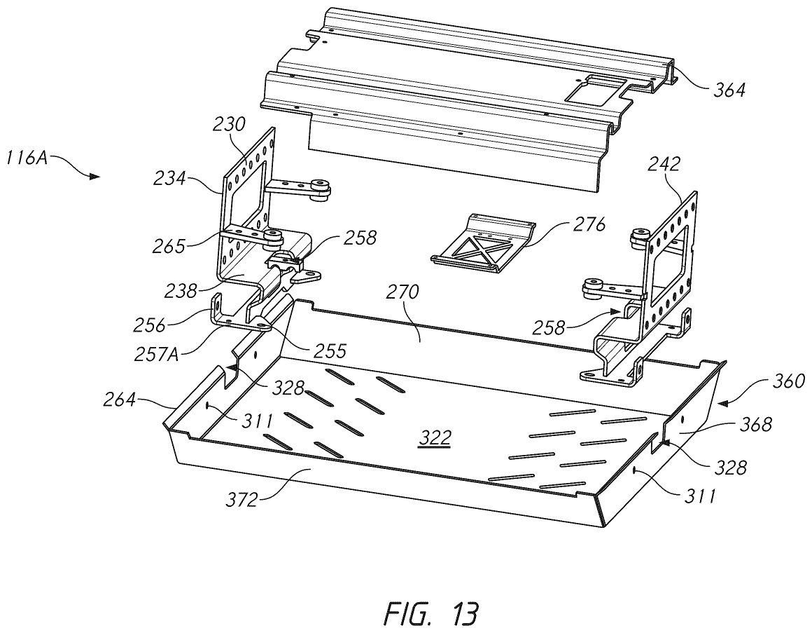

FIGS. 7 and 8-13 show a longer wheelbase vehicle assembly 80 that has a frame assembly 86 with frame rails 88. A frame rail 88A and a frame rail 88B of the frame assembly 86 can have the same structure as the frame rail 48A and the frame rail 48B. FIGS. 1 and 7A show that the frame rails 48 and the frame rails 88 can be perforated, having an array of holes used for coupling components to the frame assembly 46 of the vehicle assembly 40 or to the frame assembly 86 of the vehicle assembly 80. The frame assembly 46 and the frame assembly 86 can support an axle 54 to rotate wheels to drive the vehicle assembly 40 or the vehicle assembly 80.

In one application, the vehicle assemblies 40, 80 are stock vehicle assemblies. In some cases, these vehicle assemblies may have been designed to operate with an internal combustion engine. However, modules disclosed herein can re-configure the vehicle assembly 40 or the vehicle assembly 80 to operate by an electric drivetrain system 98.

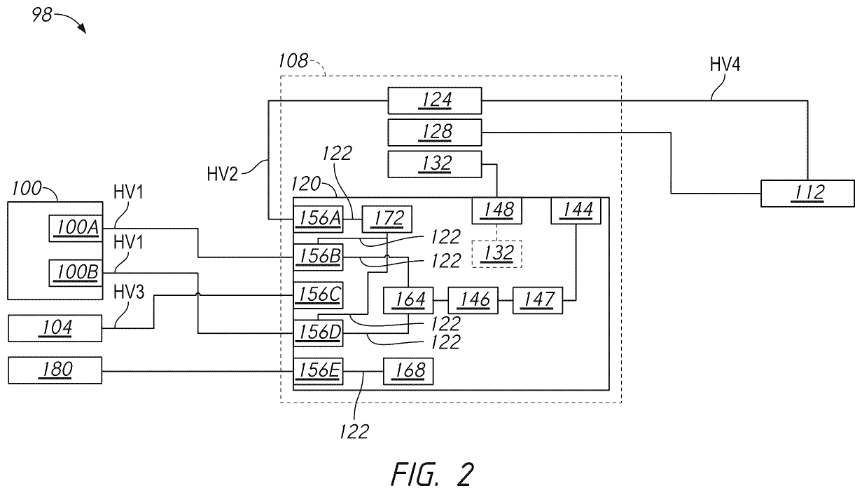

FIGS. 1-2 show that the electric drivetrain system 98 can include a battery assembly 100 and an axle drive assembly 112 coupled with the axle 54. The battery assembly 100 can store and supply electrical power to the axle drive assembly 112 to rotate wheels coupled with the axle 54 as directed by the electric drivetrain system 98. The electric drivetrain system 98 also includes a power distribution assembly 108 that can be electrically coupled with the battery assembly 100 and the axle drive assembly 112 to provide for motion of the vehicle assembly 40. The electric drivetrain system 98 also can include a front end accessory component assembly 104. The power distribution assembly 108 can direct power from the battery assembly 100 or another source of power of the electric drivetrain system 98 to the front end accessory component assembly 104. The electric drivetrain system 98 can be equipped with one or more range extender modules to supply electrical power either to the axle drive assembly 112 or to recharge the battery assembly 100. The electric drivetrain system 98 can also employ regenerative braking to use the work of braking to add charge to the battery assembly 100. The electric drivetrain system 98 can also be configured to provide external power to one or more other electrical loads on or around the vehicle assembly 40.

As discussed further below the electric drivetrain system 98 may employ a large number of components to provide advantageous functions to the vehicle assembly 40. Connecting these many components to the vehicle assembly 40 would be labor intensive and costly. For example, if distinct functional components are mounted to the frame assembly 46 individually, the vehicle assembly 40 will be required to carry excess weight of dedicated brackets and fasteners. Also, the available space on the vehicle assembly 40 for such components is limited. The power distribution assembly 108 facilitates convenient connection to the frame assembly 46 and also avoids redundant brackets while occupying a reduced or minimal amount of frame rail space, as described further below. Also, by providing fewer separately mounted components and assemblies with dedicated mounting locations and brackets, e.g., with only two mounting locations and in some cases only one mounting location along the frame rails, serviceability is much improved.

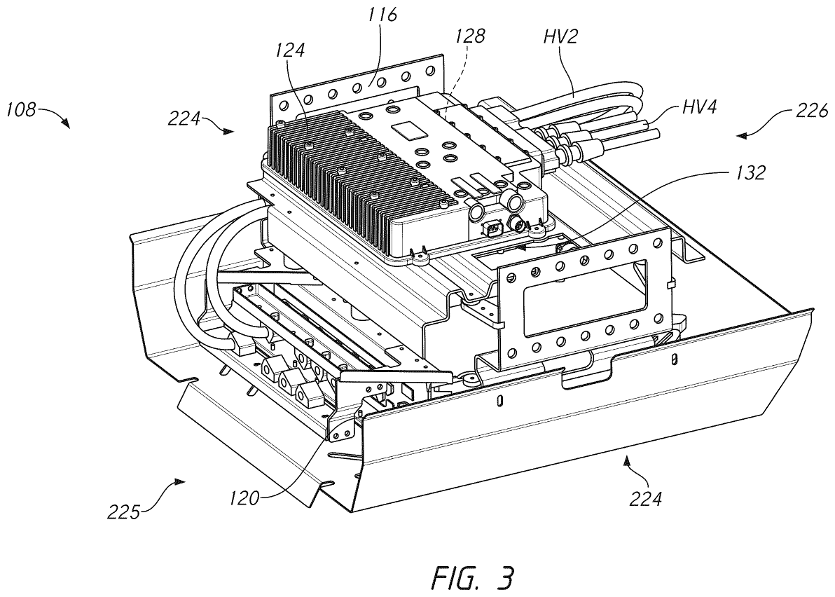

FIGS. 2 and 3 illustrate the power distribution assembly 108 in greater detail. The power distribution assembly 108 includes a mounting system 116 and a power distribution unit 120. The power distribution assembly 108 has lateral sides 224, a forward facing side 225, and a rearward facing side 226. The forward facing side 225 is configured to be oriented toward a forward portion of the vehicle assembly 40 when applied thereto. In some applications the power distribution assembly 108 is configured to be mounted adjacent to a battery assembly 100 so that the forward facing side 225 is configured to simplify routing of high voltage cables between these components.

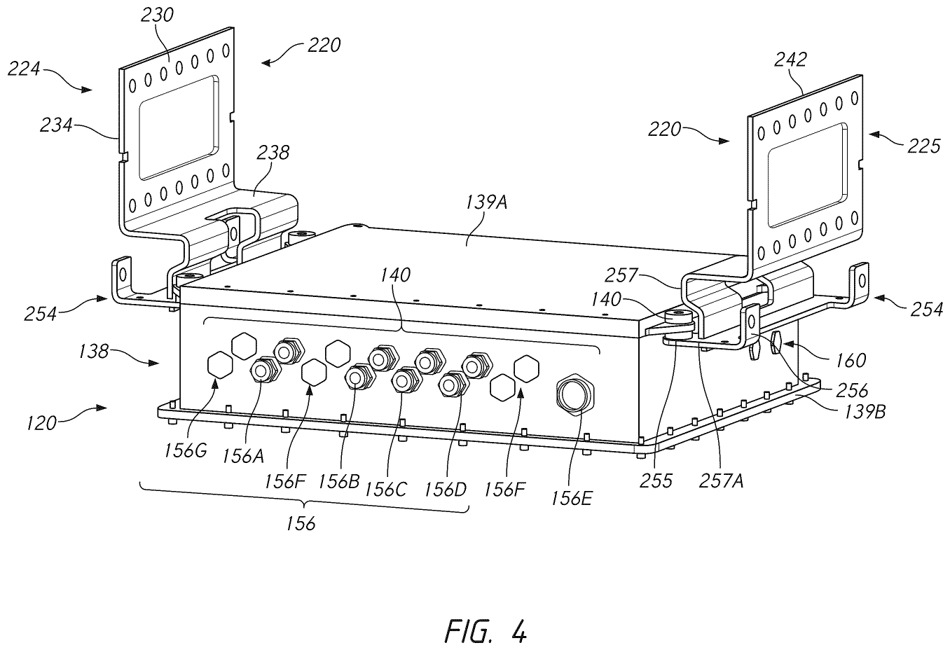

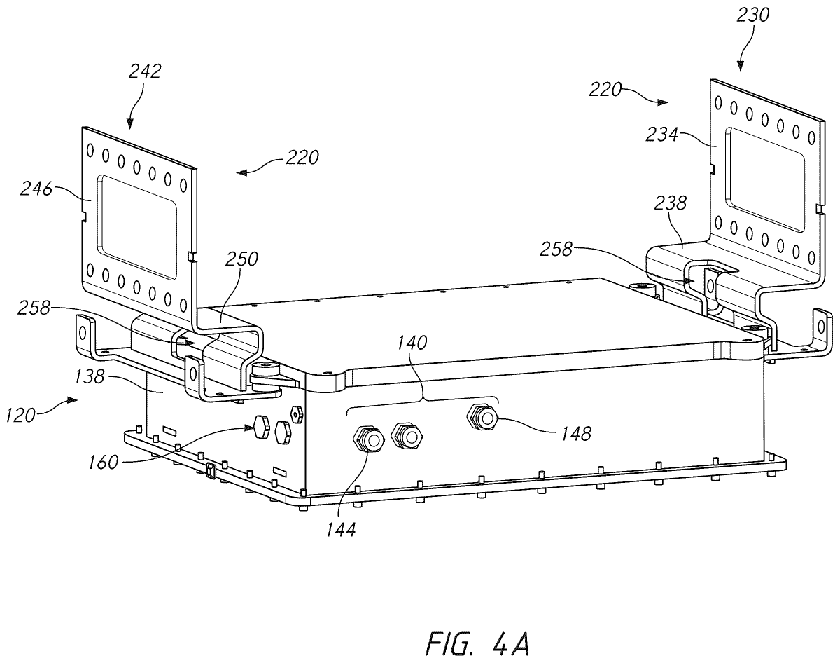

The power distribution unit 120 provides an integration of a plurality of core operational components of the electric drivetrain system 98 that provides for a single point of mounting for these core components within the power distribution assembly 108. The power distribution unit 120 includes a housing 138 (shown in FIGS. 4-4A) that can be sealed against the ingress of dust, debris and/or moisture. The housing 138 can be provided with a cable interface 140 (shown in FIGS. 4-4A) disposed on one of the external surfaces thereof. The cable interface 140 can be disposed on a forward facing side of the housing 138. For example, the housing 138 can have a generally rectangular configuration with a forward vertical side upon or through which the cable interface 140 is disposed. The cable interface 140 can include a number of cable gland connectors that can be provided at each of a plurality of high voltage cable junctions 156. FIG. 2 shows that a current cable junction 156A can be provided to enable high voltage current to be transferred out of the power distribution unit 120 to an inverter 124 of the electric drivetrain system 98 by way of a high voltage cable HV2. The inverter 124 can supply lower voltage current to the axle drive assembly 112 by way of a high voltage output cable HV4. If regenerative braking is employed, current can also flow from the axle 54 to the inverter 124 and thereby through the high voltage cable HV2 to the first junction 156A. The current flowing in this direction can be directed into the battery assembly 100 via the high voltage cables HV1 to partly recharge the battery cells thereof.

The power distribution unit 120 can include a second junction 156B and a fourth junction 156D that can be coupled with the battery assembly 100 by way of high voltage cables HV1. In the illustrated embodiment, the battery assembly 100 has a first battery cell sub-assembly 100A and a second battery cell sub-assembly 100B. The first battery cell sub-assembly 100A and the second battery cell sub-assembly 100B can be connected in parallel to provide redundant sources of power in case either of the cell sub-assemblies become depleted, underperforming or inoperable. The power distribution unit 120 also can include a third junction 156C provide for high voltage current to the front end accessory component assembly 104 by way of a high voltage cable HV3. A fifth junction 156E can provide for connection to a vehicle control unit 180 to power and operate other components of the power distribution assembly 108 and to enable the vehicle control unit 180 to receive information about the operation of the vehicle.

The power distribution unit 120 can regulate the flow of current to and from the various components of the electric drivetrain system 98 by way of the current cable junctions 156. For example, the power distribution unit 120 facilitates charging the battery assembly 100. In one mode, a high voltage DC power source can be connected to a DC charge port inlet 144 disposed on an external surface of the housing 138. The DC charge port inlet 144 can include a first connection for a positive polarity and a second connection for a negative polarity. The DC charge port inlet 144 can be coupled to the second junction 156B and the fourth junction 156D by a DC charge controller 164. The DC charge controller 164 can include or can be coupled with one or more, e.g., with two, DC charge contactors 146 to regulate the flow of DC power during charging. The DC charge controller 164 can also include or can be coupled with a DC charge polarity sensor 147 to detect the polarity of the power source, e.g., the charging station to avoid a fault in charging.

The power distribution unit 120 also can include current and voltage sensors 168 which can serve various functions, including determining how much current is being drawn by the axle drive assembly 112. Fuses 122 are provided in the power distribution unit 120 to cease operation in some of the current paths upon a short or other unanticipated fault.

The power distribution unit 120 also can include one or more contactors 172, e.g., a drive contactor, to regulate the flow of current through the first junction 156A to the inverter 124. The contactor 172 can be actuated by software operated by the vehicle control unit 180 which can detect a fault in operation, and when a fault is detected, cause the contactor 172 to cut current to the inverter 124 and thereby to the axle drive assembly 112. The contactor 172 also can be connected to a switch in the cab 42 allowing the operator of the vehicle assembly 40 to cut current to the axle drive assembly 112 manually.

The power distribution unit 120 can also include an AC charge port inlet 148 which can enable the power distribution assembly 108 to recharge the battery assembly 100 by way of an AC power source. The AC charge port inlet 148 can be coupled with an AC charge circuit 132 which can include a converter for providing DC power to the power distribution unit 120 by way of the AC charge port inlet 148. The DC charge port inlet 144 and the AC charge port inlet 148 can be connected internally to the second junction 156B and/or the fourth junction 156D by way of internal wiring of the power distribution unit 120. As a safety measure, the power distribution unit 120 also can include an active discharge circuit. The active discharge circuit can include a contractor and a resistor to interrupt current and to dissipate any charge that may otherwise be present in the power distribution unit 120. The power distribution unit 120 advantageously collect these various electrical components in a single unit, disposed within the power distribution assembly 108.

FIGS. 3 and 4 show one way of supporting the power distribution unit 120 in the mounting system 116. In the illustrated embodiment the power distribution unit 120 is suspended from a top portion or top cover of the housing 138. The mounting system 116 can include a first bracket 230 and a second bracket 242. In variations, the mounting system 116 also can include vibration isolators 252 disposed between the first bracket 230 and the top cover 139A of the housing 138 and between the second bracket 242 and the top cover 139A of the housing 138. The vibration isolators 252 reduce, minimize or eliminate frame twist and/or on-road vibration as seen at the power distribution assembly 108, e.g. at the power distribution unit 120. These brackets can form a frame rail interface 220 for the power distribution assembly 108 and can constitute the only point of connection to the frame rails 48 or the frame rails 88 in some embodiments. One or both of the first bracket 230 and the second bracket 242 can include a plate member having an array of apertures for connecting to corresponding apertures in the frame assembly 46. For example, the first bracket 230 can include a vertical portion 234 that includes an oblong, oval, or rectangular shaped plate provided with an upper array of holes and a lower array of holes. The upper and lower arrays of holes can be provided on generally horizontally oriented plate members of the vertical portion 234. The end portions of the horizontally oriented plate members can be connected by vertical plate members of the vertical portion 234. The horizontal and vertical plate members can be all one unitary body, such as may be stamped out of sheet metal. The first bracket 230 can include a horizontal portion 238 extending between the vertical portion 234 and a lower portion 254 of the first bracket 230. The vertical portion 234 is configured to fit within the concave cross-section 50 of the frame rails 48 as shown in FIG. 7A, discussed further below. The horizontal portion 238 is configured to extend outwardly sufficiently to allow the vertical portion 234 to overlap the vertical surface 56 of the frame rail 48A (and in the case of the frame rail 48B, the vertical portion 234 of the second bracket 242 to overlaps the vertical surface 56 thereof). In other words, the horizontal portion 238 extends the vertical portion 234 to the proper position relative to the frame rails 48 such that the vertical portion 234 can be secured to the frame rails 48. The connection of the vertical portion 234 to the frame rails 48 can be by bolts extended through holes of the array of holes in the frame rails 48 and the holes in the vertical portion 234. While a particular arrangement of the bracket (e.g., first bracket 230 and second bracket 242) and the frame rail 48 is disclosed, in other embodiments, the brackets may be arranged relative to the frame rail 48 and/or coupled to the frame rail 48 differently.

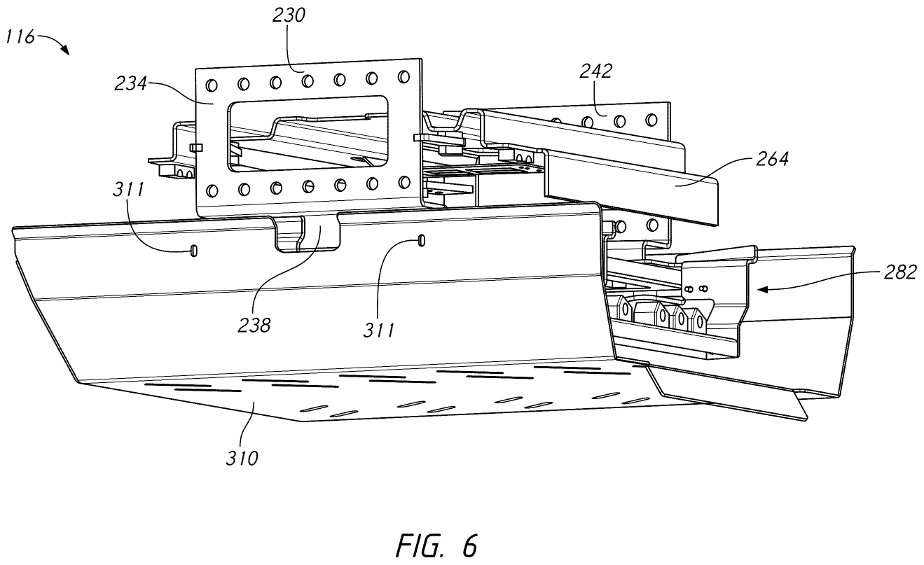

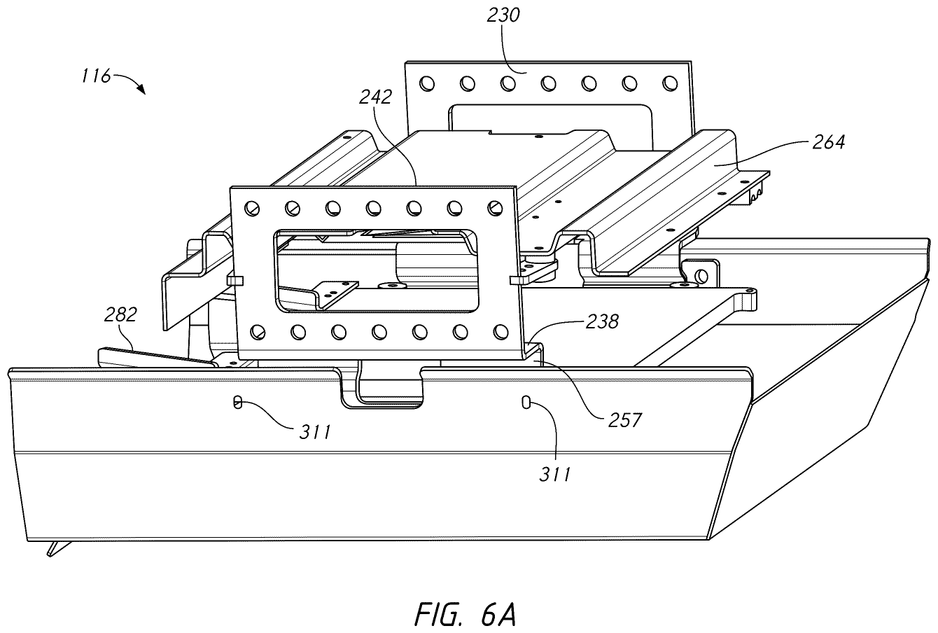

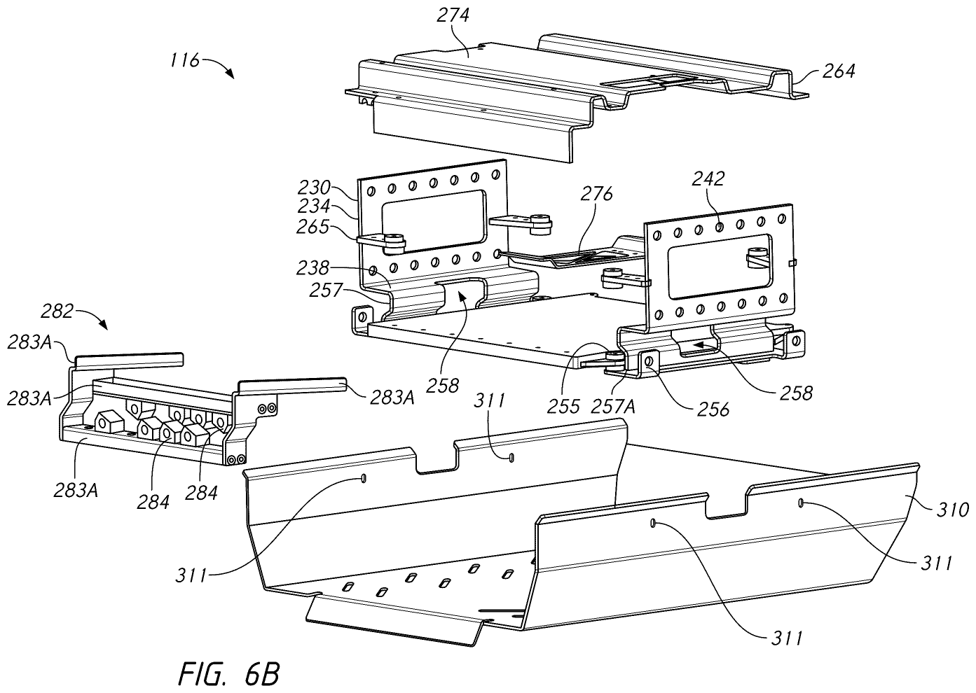

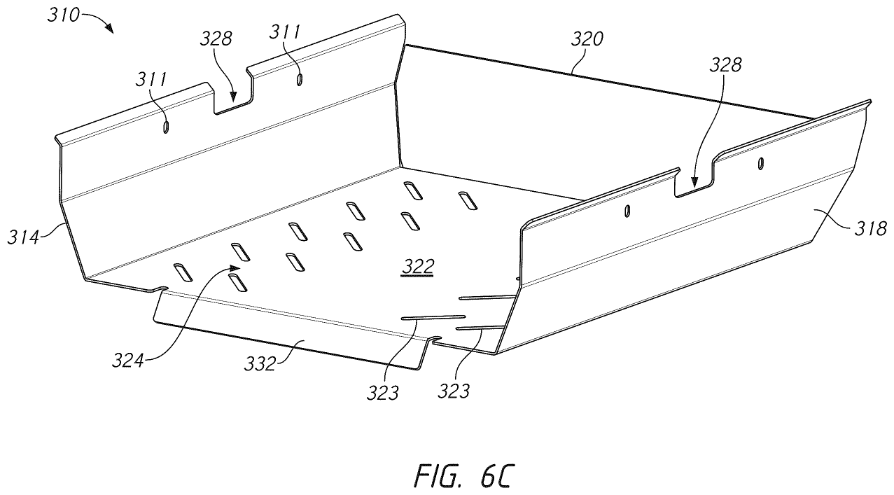

The power distribution unit 120 is supported from a top portion, e.g., from a top cover 139A thereof. As a result, almost the entirety of the height of the housing 138 of the power distribution unit 120 is below the supporting brackets of the mounting system 116. Thus, the power distribution unit 120 is hung below the frame rails 48 when applied. The top cover 139A can include a horizontal plate member and the side surface of the housing 138 in a concave shell assembly. As discussed further below, this arrangement allows the service panel 139B to be accessed more easily by simply removing a debris deflector 310 (shown in FIGS. 6-6C) of the mounting system 116. In particular, the service panel 139B can be secured to a lower portion of the top cover 139A by a plurality of bolts and by a gasket to maintain the internal space dry.

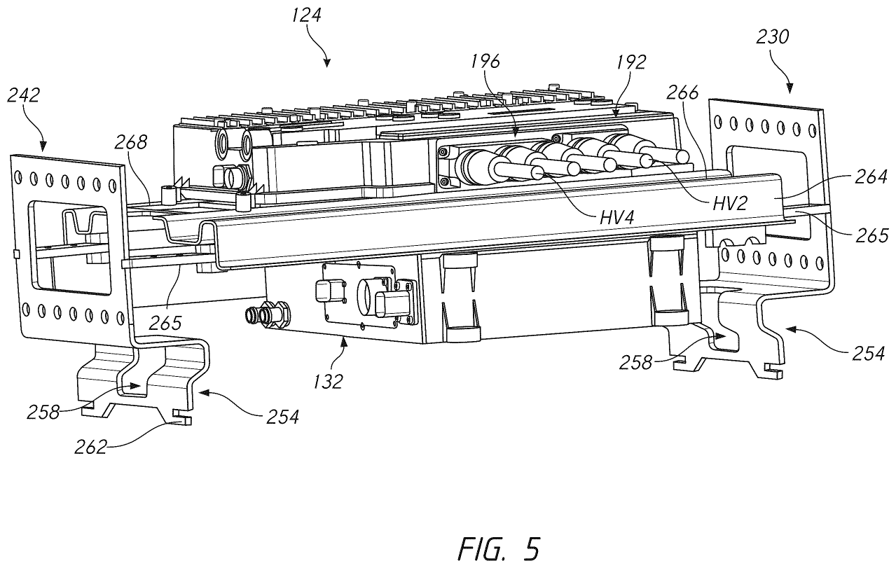

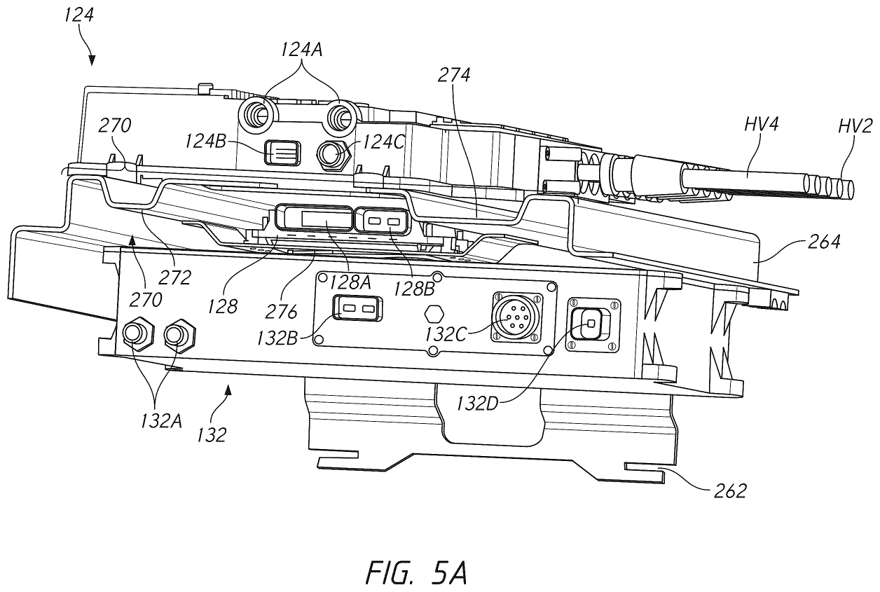

The lower portion 254 of the first bracket 230 and the second bracket 242 can have an inward end 255 adjacent to the housing 138 configured to secure the top cover 139A of the housing 138. The inward end 255 can include or be coupled with a damper, spring or other vibration isolator 252 for coupling an outward flange of the top cover 139A, e.g., with a bolt or other fastener. The outward end of the lower portion 254 can have an upwardly extending free end 256 configured to engage the debris deflector 310 as discussed further below. FIG. 5 shows that the lower portion 254 can include an assembly of multiple components. The lower portion 254 can include a unitary construction of a downwardly extending expanse 257 and the horizontal portion 238. The downwardly extending expanse can extend outwardly below the horizontal portion 238 to provide clearance for the vibration isolator disposed between the power distribution unit 120 and the first bracket 230 and between the power distribution unit 120 and the second bracket 242. A free end of the downwardly extending expanse of the horizontal portion 238 can include one or a plurality of, e.g., two, assembly slots 262 for assembling the first portion of the lower portion 254 to a second portion. The second portion comprises a separate or separable generally horizontal plate member 257A with the upwardly extending free end 256 at an outer portion and the inward end 255 configured to couple with the top cover 139A of the housing 138 via the vibration isolator. One side of the generally horizontal plate member 257A can be slotted to engage the assembly slots 262 to form the multipart assembled lower portion 254. FIGS. 4 and 4A show that the mounting system 116 can include four plate member 257A, each supporting one of the four corner areas of the housing 138.

The lower portion 254 preferably has a clearance opening 258 disposed therethrough. The clearance opening 258 can be disposed in the lower portion 254 below and inward of a central portion of the vertical portion 234. The clearance opening 258 can extend into the width of the horizontal portion 238. The clearance opening 258 can extend at least about a quarter of the length of horizontal portion 238. The clearance opening 258 provides clearance for a fastener 118 used in assembling the vehicle assembly 40. As discussed further below, the fastener 118 can be or can include a U-bolt as is used by truck bodybuilders to couple a load carrying assembly to the frame assembly 46. The fastener 118 may or may not play any role in supporting the mounting system 116, as discussed further below.

The power distribution unit 120 preferably is modular in that the components coupled therewith can be extended as beneficial to the application. For some applications, the vehicle assembly 40 is expected to be eventually deployed in a setting in which greater range is preferred. In such an arrangement the power distribution unit 120 can be coupled with one or more range extending modules. For example, the battery assembly 100 can be a first battery assembly and the vehicle assembly 40 can be coupled with a second battery assembly 100 if space on the frame assembly of the vehicle allows. Alternatively, the vehicle assembly 40 can be provided with a fuel cell module or other current generator to provide for replenishing battery cells within the battery assembly 100.

FIG. 4 shows that the power distribution unit 120 has range extender openings 156F disposed among the current cable junctions 156. The range extender openings 156F are enclosed by caps in the illustrated view but could be equipped with gland connectors to be connected to a second battery assembly 100 and/or to a fuel cell module or other current generator to extend the range of the vehicle. The power distribution unit 120 also includes auxiliary load openings 156G that are covered in the illustrated embodiment but could be equipped with gland connectors to enable the power distribution unit 120 to be electrically connected to a second axle drive assembly 112, for example. Further extension of the power distribution unit 120 is also possible. For example as illustrated in FIG. 4, external power take off openings 160 can be provided on a lateral surface of the housing 138. The external power take off openings 160 are covered but, the covers can be removed and an appropriate connector can be provided to engage an electrical conveyance configured to provide current to an accessory of the vehicle assembly 40, e.g., a refrigeration unit of a refrigerator truck, a light of a cargo box of a cargo truck, an external motor, a power module, a pump, or other external power needs on or around the vehicle assembly 40.

FIG. 4A shows that the DC charge input 144 and the AC charge input 148 to the power distribution unit 120 can disposed on a side surface of the housing 138, e.g., on a rear-facing side thereof. Other locations for these ports are possible. The AC charge port inlet 148 is configured to be coupled with the AC charge circuit 132, which is configured to convert the AC power to DC power to be delivered to the AC charge port inlet 148.

FIG. 5 show additional features of the power distribution assembly 108 and the mounting system 116 for supporting such features. The mounting system 116 includes an upper tray 264 that is configured to support multiple components of the power distribution assembly 108. The upper tray 264 has a first lateral portion 266 and a second lateral portion 268 that couple with the first bracket 230 and the second bracket 242 respectively. The upper tray 264 can be supported by vibration isolators (dampers, springs, etc.) supported on plate members 265 extending inwardly from the inner side of the first bracket 230 and the second bracket 242. The vertical position of the projections can be between the upper hole array and the lower hole array on the vertical portion 234, e.g., halfway up the vertical portion 234. The upper tray 264 can have a crenulated configuration, e.g., including a plurality of upward and downward extensions providing a plurality of upward facing channels and a plurality of downward facing channels. The upper tray 264 can include an undulating portion 270 that extends between forward and rearward portions of the upper tray 264. These channels provide clearance for fasteners, e.g., for bolt heads, nuts and for other components of the power distribution assembly 108. The undulating shape also provided enhanced stiffness so that components can be mounted to the upper tray 264 such that limited to no deflection between mount points and/or a thinner and lighter construction can be provided. In the illustrated embodiment, the inverter 124 is mounted to an upper side 274, e.g., to a top surface of the upper tray 264. The AC charge circuit 132 can be mounted to a bottom side, e.g., to a bottom surface of the upper tray 264.

FIG. 5 shows that a bottom surface of the AC charge circuit 132 can be spaced above the assembly slots 262 to which the connection features for supporting the top cover 139A of the power distribution unit 120 are mounted. Thus, the mounting system 116 enables a vertical stacking of the power distribution unit 120, the AC charge circuit 132, and the inverter 124 in the illustrated embodiment. These three components can be supported in the mounting system 116 with a single tray, allowing for a lighter weight construction. The inverter 124 has a cable interface 192 to couple with the high voltage cables HV2 and has a cable interface 196 to couple with the high voltage cables HV4 The inverter 124 is configured to change the high voltage DC current flowing through the high voltage cables HV2 to three phase high voltage power in the high voltage cables HV4. Three phase high voltage power is used by the axle drive assembly 112 to propel the vehicle assembly 40 or the vehicle assembly 80. The cable interface 192 and the cable interface 196 can be located on a rear-facing side of the inverter 124 as mounted in the power distribution assembly 108. Other orientations are also possible for the cable interface 192.

FIG. 5A shows a lateral view of an assembly including the upper tray 264, the inverter 124 and the AC charge circuit 132. The mounting system 116 also includes a shelf 276 that supports a powertrain control circuit 128. The powertrain control circuit 128 can be nested in a space defined between an upper surface of the shelf 276 and a lower side 272, e.g., a lower surface, of the upper tray 264. A space efficient arrangement provides that the powertrain control circuit 128 is partly received in a downward facing channel of the upper tray 264. The shelf 276 is shaped such that an upper side that couples with the powertrain control circuit 128 is concave such that a portion of the thickness of the powertrain control circuit 128 is received within the concavity of the upper side. The powertrain control circuit 128 is thus fit between the inverter 124 and the powertrain control circuit 128, e.g., between the upper tray 264 and the AC charge circuit 132.

FIG. 5A shows lateral sides of the inverter 124, the powertrain control circuit 128, and the AC charge circuit 132, which all provide for connection of these components to other components of the system. The inverter 124 includes one or more coolant connections 124A for one or more coolant loops to allow for active liquid cooling of the inverter 124. The coolant can be pumped from the front end accessory component assembly 104 on a forward part of the vehicle assembly 40. The inverter 124 also has a low voltage control port 124B whereby the vehicle control unit 180 can control the operation support operation of the inverter 124. The inverter 124 can include resolver cable connection 124C. The resolver cable connection 124C can receive data indicative of the position of the axle drive assembly 112 for purposes driving the motor.

The powertrain control circuit 128 has a low voltage control port 128A and a sensor port 128B that connects to the vehicle control unit 180. The vehicle control unit 180 can operate certain aspects of the powertrain control circuit 128. The powertrain control circuit 128 includes a low voltage control port 128A for connection to sensors or other data sources coupled with the axle 54, the inverter 124, and other components supporting the operation of the powertrain.

The AC charge circuit 132 also has a plurality of ports supporting the operation thereof. In the illustrated embodiment, a lateral side of the AC charge circuit 132 has a plurality of coolant connections 132A for one or more coolant loops to provide for active liquid cooling of the AC charge circuit 132. The coolant can be pumped from the front end accessory component assembly 104. In one embodiment, the AC charge circuit 132 and the inverter 124 are on the same coolant loop and may be coupled in parallel to provide enhanced cooling. In some approaches, these liquid cooled components may be coupled in series, such that one of the coolant connections 124A outputting the coolant fluid that has already cooled the inverter 124 can flow into a cool side of the coolant connections 132A of the AC charge circuit 132 to cool the charge circuit. In another embodiment, a hot side port of the coolant connections 132A on the AC charge circuit 132 can be directed into a cool side of the coolant connections 124A of the inverter 124 to cool the inverter. In a further embodiment, a source of coolant can be actively controlled through a manifold and a control valve to modulate the amount of coolant that is directed from a source of coolant to each of the AC charge circuit 132 and the inverter 124 such that the amount of coolant directed to each component will depend on the coolant needs of each at the given time. A sensor can be placed on or adjacent to a surface of the AC charge circuit 132 or the inverter 124 and/or in or adjacent to the fluid stream exiting the AC charge circuit 132 or the inverter 124 as in input to a control system and method for such regulated cooling. The AC charge circuit 132 can also include a low voltage control port 132B that can be coupled with the vehicle control unit 180 or other controller to provide a low voltage control signal to the AC charge circuit 132. The AC charge circuit 132 can have an AC inlet 132C that is configured to receive AC current for charging the battery assembly 100. The AC power is converted in the AC charge circuit 132 into low voltage DC current, which is output via an AC low voltage DC output 132D. The low voltage DC output 132D can be coupled with the AC charge port inlet 148 on the power distribution unit 120.

FIGS. 6-6C show the mounting system 116 with the electrical components of the power distribution assembly 108 removed to illustrate more detail of various embodiments of this component. The mounting system 116 includes the first bracket 230 and the second bracket 242. As discussed above, these brackets allow for connection to inward facing surfaces of the frame rails 48. As noted above, the first bracket 230 includes the vertical portion 234 with an array of holes configured to align with an array of holes on the frame rails 48 such that the vertical portion 234 can be secured to the frame rails 48. The horizontal portion 238 allows the vertical portion 234 to extend outwardly to position the vertical portion within the concave cross-section 50 of the frame rails 48. Or, said another way, the horizontal portion 238 projects inwardly from the vertical portion 234 such that points of connection to the power distribution unit 120 can be horizontally inward of point of connection to the frame rail 48A and frame rail 48B, e.g., the points of connection to the power distribution unit 120 can be closer to the central vertical plane CP of the vehicle assembly 40 than are the points of connection to the frame rails 48. The mounting system 116 can thus be disposed within a vertical envelop defined by the outer sides of the vertical portions 234 of the first bracket 230 and the vertical portion 234 of the second bracket 242.

The debris deflector 310 can be coupled with the mounting system 116 and may extend laterally beyond the outer sides first bracket 230 and the second bracket 242, e.g., outside of the vertical portion 234. The debris deflector 310 can extend to a position vertically below the frame rails 48 but generally within the width of the outer side of the frame rails 48. The debris deflector 310 can include openings 311 to secure the debris deflector 310 to the free end 256 of each of four or more plate members 257A. Thus, the debris deflector 310 can be easily connected to the mounting system 116 and easily removed therefrom without removing the power distribution assembly 108 from the vehicle assembly 40. This configuration provide convenient access to the power distribution unit 120 for service because with the debris deflector 310 removed, the lowest structure of the power distribution assembly 108 is the service panel 139B of the housing 138. The service panel 139B can removed by removing an array of bolts connecting the service panel 139B to the top cover 139A. Service personnel can thus access system fuses and other serviceable components located within the housing 138.

FIG. 6B shows a horizontal member of the top cover 139A secured to the inward ends 255 of each of a plurality of (e.g., four) plate member 257A of the mounting system 116. In one embodiment, the power distribution unit 120 is coupled to the first bracket 230 and the second bracket 242 by way of the top cover 139A without requiring any dedicated tray. In other embodiments, a tray can be provided at the location where the horizontal member of the top cover 139A is illustrated. If present, the tray could then be secured to the top cover 139A or other components of the power distribution assembly 108 in a suitable manner, e.g., by way of one or more vibration isolators.

FIG. 6B shows that the mounting system 116 also can include a cable strain relief module 282. The cable strain relief module 282 can be positioned on the forward facing side 225 of the power distribution assembly 108, e.g., just forward of the current cable junctions 156 of the power distribution unit 120. The cable strain relief module 282 can be placed between the power distribution assembly 108 and the battery assembly 100 when both are disposed on the vehicle assembly 40. The cable strain relief module 282 can be supported in any suitable manner. In one approach the cable strain relief module 282 includes a frame assembly comprising two spaced apart brackets 283A and upper and lower support bars 283B. The brackets 283A can be configured to couple to an upper side of the housing 138, e.g. to a top surface of the top cover 139A. The brackets 283A can project forwardly of the housing 138 and can include vertical portions that support opposite ends of the support bars 283B. The support bars 283B can support a plurality of cable strain relief components 284. Some of the cable strain relief components 284 can be supported from above and some of the cable strain relief components 284 can be supported from below by the support bars 283B. The cable strain relief components 284 can include slip rings, clamps or other immobilizers configured to reduce, minimize or eliminate motion of the high voltage cable HV1, the high voltage cable HV2, and the high voltage cable HV3 routed into and out of the current cable junctions 156. In one approach, each upper cable strain relief component 284 coupled with the upper support bars 283B can secure and help to avoid stain on positive polarity high voltage cables. Each lower cable strain relief component 284 coupled with the lower support bars 283B can secure and help to avoid stain on negative polarity high voltage cables. The vertically staggered arrangements helps visually confirm proper polarity of the high voltage cable. The cable strain relief component 284 can also be used as strain relief of a cable connection the vehicle control unit 180 to the fifth junction 156E or of any additional cables that would be coupled with gland fittings coupled with the range extender openings 156F or the auxiliary load openings 156G.

Mounting the power distribution assembly 108 beneath the frame assembly 46 provides many advantages to preparing the vehicle assembly 40 to operate with the electric drivetrain system 98. However, that position exposes the components of the power distribution assembly 108 to road debris. The debris deflector 310 provides protection for the electrical components of the power distribution assembly 108. FIG. 6C shows that the debris deflector 310 includes a first lateral side 314, a second lateral side 318, a rear side 320 and an opening 324 disposed on the front side of the debris deflector 310. The debris deflector 310 includes a floor 322 that extends between lower ends of the sides 314, 318, 320. A forward edge of the debris deflector 310 includes a projection 332 that extends downward from the floor 322 that enhances the stiffness of the debris deflector 310. The floor 322 is equipped with slots 323 that allow water to flow out of the power distribution assembly 108 in rain conditions. The opening 324 provides a generally straight line pass-through of the high voltage cable HV1 and the high voltage cable HV3 between the power distribution assembly 108 and the battery assembly 100 and front end accessory component assembly 104. The opening 324 also eliminates possible contact between the high voltage cable HV2 and an inner wall of the debris deflector 310 the high voltage cable HV2 is routed from the front side of the power distribution unit 120 to the rear side of the inverter 124.

The debris deflector 310 also includes a pass-through 328 on each of the first lateral side 314 and the second lateral side 318. The pass-through 328 can include a notch or slot along a top edge of the first lateral side 314 and along a top edge of the second lateral side 318. The pass-through 328 allows a fastener 118 for securing box truck elements to the frame assembly 46, as discussed further below, as discussed below in connection with FIGS. 7 and 7A. The openings 311 in upper portions of the first lateral side 314 and the second lateral side 318 allow the debris deflector 310 to be secured to the mounting system 116, e.g., to the free end 256 of the plate members 257A of the lower portion 254 of the first bracket 230 and the second bracket 242. The debris deflector 310 can be easily removed by disconnecting fasteners from these openings 311 allowing the debris deflector 310 to be removed below the power distribution assembly 108. The top portion of the debris deflector 310 is also further configured to facilitate connection to a vehicle by being outwardly tapered. In particular, the lateral sides of the debris deflector 310 are wider at uppermost portions thereof than below such uppermost portions. As such, as the power distribution assembly 108 is advanced up against frame rails 48 the uppermost portions can be deflected somewhat outwardly and/or the free end 256 of the plate member 257A can be deflected by the debris deflector 310 such that the deflector is generally centered on the central vertical plane CP of the vehicle assembly 40.

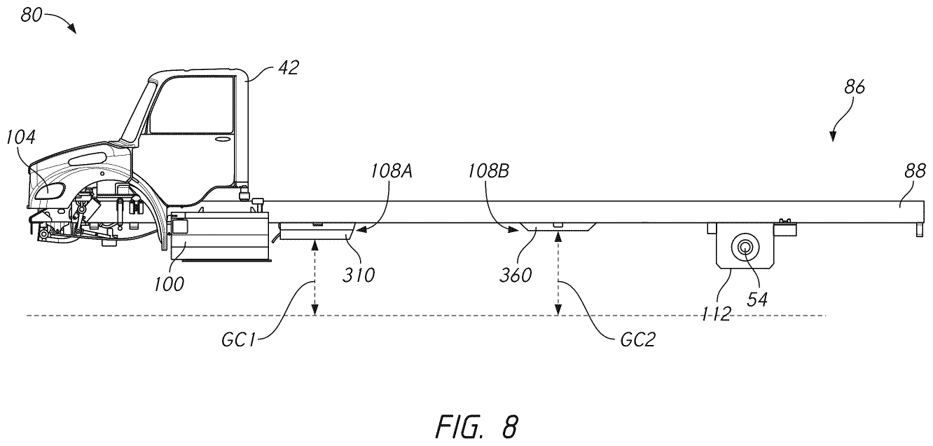

FIG. 8 shows another example of a vehicle assembly 80. The vehicle assembly 80 is similar to the vehicle assembly 40 and like features have like numerals. The descriptions of common features are not repeated, but are incorporated into the description of FIG. 8. The vehicle assembly 80 includes a frame assembly 86 that has a longer wheelbase. The frame rails 88 are longer than the frame rails 48 which enables forward wheels to be located farther from the rearward wheels of the vehicle assembly 80. The axle drive assembly 112 is located close to the axle 54 of the rear wheels. The battery assembly 100 is disposed close to, e.g., at least partially under the cab 42. The distance between the rear side of the battery assembly 100 and the axle drive assembly 112 is much longer due to the greater wheelbase. In some cases it is desirable to keep the length of the high voltage output cable HV4 in the vehicle assembly 80 relatively short. This can be achieved by separating some of the components of the power distribution assembly 108 into a separate enclosure to be mounted separately from other components of the power distribution assembly 108. In particular a first power distribution assembly 108A can be provided that is mounted close to the battery assembly 100. A second power distribution assembly 108B can be disposed close to the axle drive assembly 112. The second power distribution assembly 108B allows a relatively short high voltage output cable HV4 to be disposed between the second power distribution assembly 108B and the axle drive assembly 112.

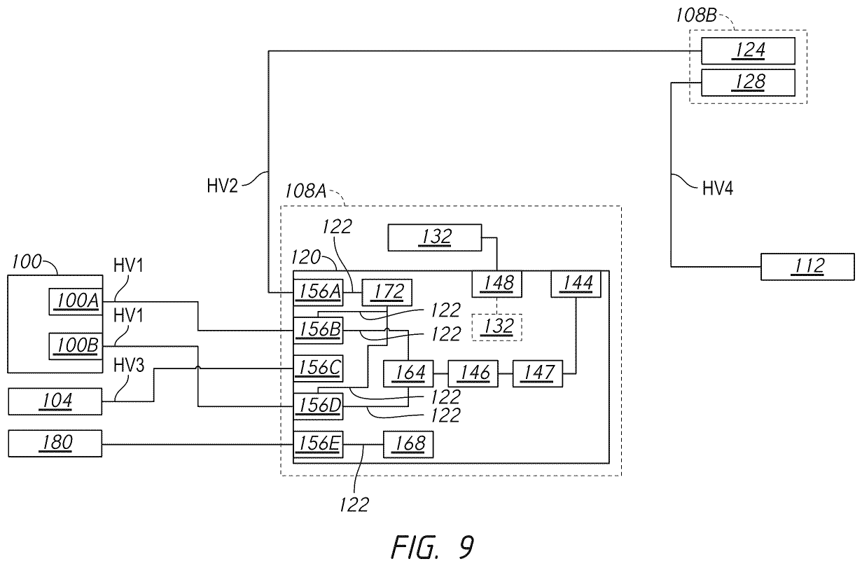

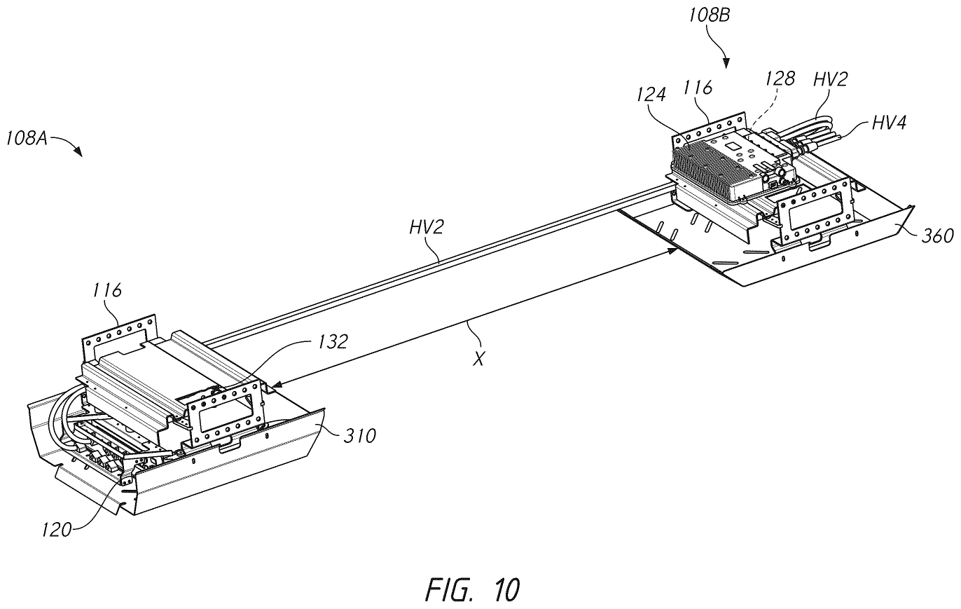

FIG. 9 shows an example schematic of the first power distribution assembly 108A and the second power distribution assembly 108B. As shown the first power distribution assembly 108A can include a unit that includes the power distribution unit 120 and the AC charge circuit 132. The second power distribution assembly 108B includes the inverter 124 and the powertrain control circuit 128. The high voltage cable HV2 is configured to span between the first power distribution assembly 108A (e.g., from the current cable junctions 156 on a forward side) to the second power distribution assembly 108B (e.g., to the rearward side of the inverter 124). Components within the power distribution unit 120 can be arranged similar to or the same as in FIG. 2. FIG. 10 shows the first power distribution assembly 108A, high voltage cable HV2 and the second power distribution assembly 108B separate from the frame assembly 86. As seen the mounting system 116 can be similar or the same as in the first power distribution assembly 108A as in the power distribution assembly 108. The mounting system 116 includes in each case the first bracket 230 and the second bracket 242 providing a frame rail interface. The brackets allow the first power distribution assembly 108A and the second power distribution assembly 108B to be mounted a spacing X from each other. In a longer wheelbase application the spacing X may be in the range of greater than two meters, e.g., about two meters to about five meters. Because the spacing X is significant, cable management components, such as clamps, can be positioned along the span of the high voltage cable HV2 traversing the spacing X. The clamps can be mounted to the frame assembly 86, e.g., within the concave cross-section 50 of one of the frame rails 88 (see FIG. 7). In other embodiments, the high voltage cable HV2 may be disposed within tubular guards or over a debris deflector configured to protect the high voltage cable HV2 between the first power distribution assembly 108A and the second power distribution assembly 108B.

FIGS. 11-13 illustrate a mounting system 116A similar to the mounting system 116 described above. The mounting system 116A has structures the same as the mounting system 116 and such common features described above are incorporated into the description that follows, which focuses on differences between the mounting system 116 and the mounting system 116A. The mounting system 116A is not required to support the power distribution unit 120 and thus the plate member 257A has an inward end 255 that can exclude or need not be coupled with a vibration isolator or other component. The free end 256 is configured to couple with a debris deflector 360 at one of a plurality of openings 311. The debris deflector 360 is similar to the debris deflector 310 except as describe differently below. As discussed above the upper tray 264 is configured to support the inverter 124 over a top portion thereof. The mounting system 116A is configured to support the powertrain control circuit 128 on the shelf 276, which is disposed under the upper tray 264 and can be coupled with the lower side 272 thereof.

The debris deflector 360 includes a first lateral side 364 and a second lateral side 368, each of which have openings 311 to couple with the free ends 256 of the plate members 257A of the mounting system 116A. As with the power distribution assembly 108, the second power distribution assembly 108B employing the mounting system 116A allows for quick access to powertrain control circuit 128 by removing the debris deflector 360 at these connection points. The debris deflector 360 includes a rear side 370 and a front side 372. The front side 372 can provide a forward deflector panel. The undulating portion 270 can provide a rearward deflector panel. The debris deflector 360 is much shallower than the debris deflector 310 due to the height of the sides 364, 368, 370, 372 from the floor 322 being less in the debris deflector 360 than the corresponding height in the debris deflector 310. The shorter height dimension provides a ground clearance benefit as seen in FIG. 8. A first ground clearance GC1 is provided between a ground surface represented by the dashed line in FIG. 8 and the bottom surface of the debris deflector 310. As second ground clearance GC2 is provided between the ground surface and the bottom surface of the debris deflector 360. As seen in FIG. 8, second ground clearance GC2 is much greater than first ground clearance GC1. The enhanced ground clearance GC2 reduces a failure mode of the electric drivetrain system 98 related to impact of the second power distribution assembly 108B with the ground. The enhanced ground clearance GC2 also allows the operator of the vehicle assembly 80 to be less concerned with driving over less even terrain and may even allow the vehicle assembly 80 to venture into more locations than if the ground clearance at the second power distribution assembly 108B were more limited.

Referring to FIGS. 7 and 7A, the power distribution assembly 108, the first power distribution assembly 108A, and the second power distribution assembly 108B each are configured to provide enhanced convenience to body builders in preventing these assemblies from disrupting normal vehicle build practices. In a typical box truck application a box assembly is coupled with the frame rails, e.g., with the frame assembly 46 and the frame rails 48. Builders often use U-bolts to connect an assembly including, for example, a box truck floor assembly by extending a plurality of U-bolts through the floor assembly and around a bottom surface of the frame rails. The U-bolt is tightened to secure the box truck floor, and ultimately the box itself, to the frame rails. A similar approach can be taken for refrigerator trucks and other utility vehicles with upper structures built onto a chassis including a frame assembly including frame rails. Advantageously the power distribution assembly 108, the first power distribution assembly 108A and the second power distribution assembly 108B are configured to accommodate a U-bolt or similar fastener 118 for integrating the assemblies into the normal build protocols of stock trucks. As noted above, the mounting system 116 includes clearance openings 258 through the first bracket 230 and the second bracket 242. The clearance opening 258 is aligned with the pass-through 328 in the debris deflector 310 or with the pass-through 328 in the debris deflector 360. This allows the power distribution assembly 108, the first power distribution assembly 108A or the second power distribution assembly 108B to be in the same location as the U-bolt used to secure the box (or other upper structure) to the frame assembly 86, e.g., to the frame rail 88A and the frame rail 88B without interfering with these fasteners.

In one build method, the first bracket 230 and the second bracket 242 are nested into the concave cross-section 50 of the frame rails 48 or the frame rails 88. Bolts are used to fully secure the power distribution assembly 108, first power distribution assembly 108A, or second power distribution assembly 108B to the frame rails through the openings in the vertical portion 234. The assemblies are hung from these connection points and no additional supports are needed to secure the assemblies to the vehicle assembly 40 or the vehicle assembly 80. The box (or other truck body) can then be placed over the frame rails and the fastener 118 can be advanced through the pass-through 328 and the clearance opening 258. If the fastener 118 is a U-bolt, a plate can be advanced through the pass-through 328 and the clearance opening 258 to complete the securing of the box (or other upper structure) to the frame rails, as shown in FIGS. 7 and 7A.

As noted above, the power distribution assembly 108, first power distribution assembly 108A, and the second power distribution assembly 108B provide a compact arrangement in each of three orthogonal directions. First, the frame rail spaces occupied by the power distribution assembly 108 is minimized because each of the power distribution unit 120, the inverter 124 and the AC charge circuit 132 as well as the powertrain control circuit 128 are secured at one position of the frame rails. The connection to the stock vehicle assembly 40 or the stock vehicle assembly 80 is by a single point of attachment rather than at two or more such points of attachment. Also the components of the power distribution assembly 108 are vertically stacked with some at least partly below and some disposed between the frame rails 48 or the frame rails 88. This advantageously leaves the rest of the frame rail length open for other components (e.g., fuel cells, additional battery assembly 100, or other vehicle components outside of the electric drivetrain system 98. The width of the power distribution assembly 108, first power distribution assembly 108A, and the second power distribution assembly 108B is also compact in that the entire envelope of the assemblies is within the width of the frame rails. Even the frame rail interface 220 (e.g., the first bracket 230 and the second bracket 242) are within the frame rail width, e.g., coupled with the inner surfaces of the concave cross-section 50 of the frame rails. This enhances the ability to connect the assemblies to stock vehicle assemblies because these components will not interfere with other components. Where possible the vertical dimension of the assemblies is reduced or kept to a minimum, e.g., as in the case of the second power distribution assembly 108B where the debris deflector 360 is shorter than the debris deflector 310. The difference in vertical dimension of the first power distribution assembly 108A and the second power distribution assembly 108B provided by incorporating dedicated debris deflectors for each unit provides better ground clearance as discussed above.

### Step Assembly and Charge Inlet

In some embodiments, the battery assembly 100 described herein may be removed from the vehicle when depleted and exchanged with another fully charged battery assembly, in lieu of charging the battery assembly 100 as it is attached to the vehicle. In other embodiments, the battery assembly 100 may be charged while attached to the vehicle through a charge inlet assembly.

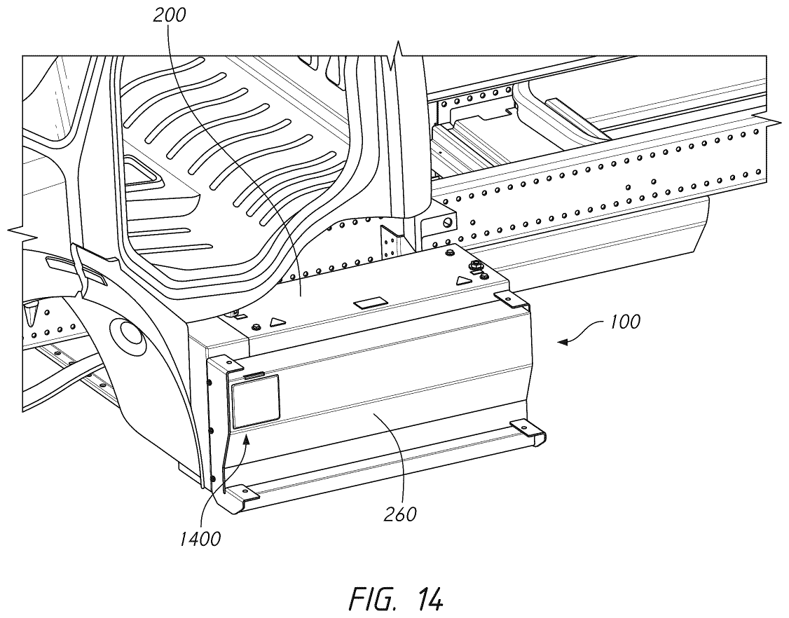

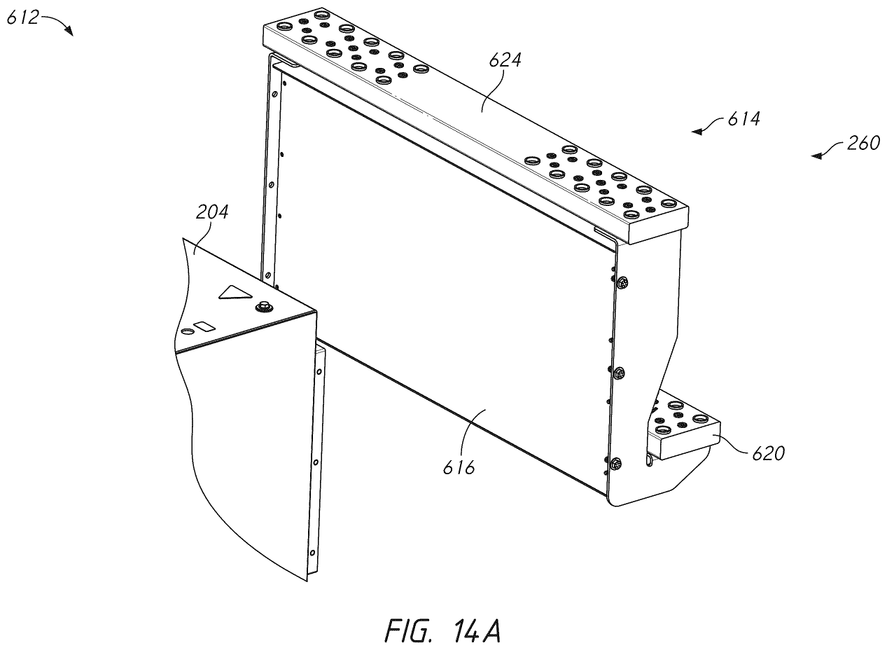

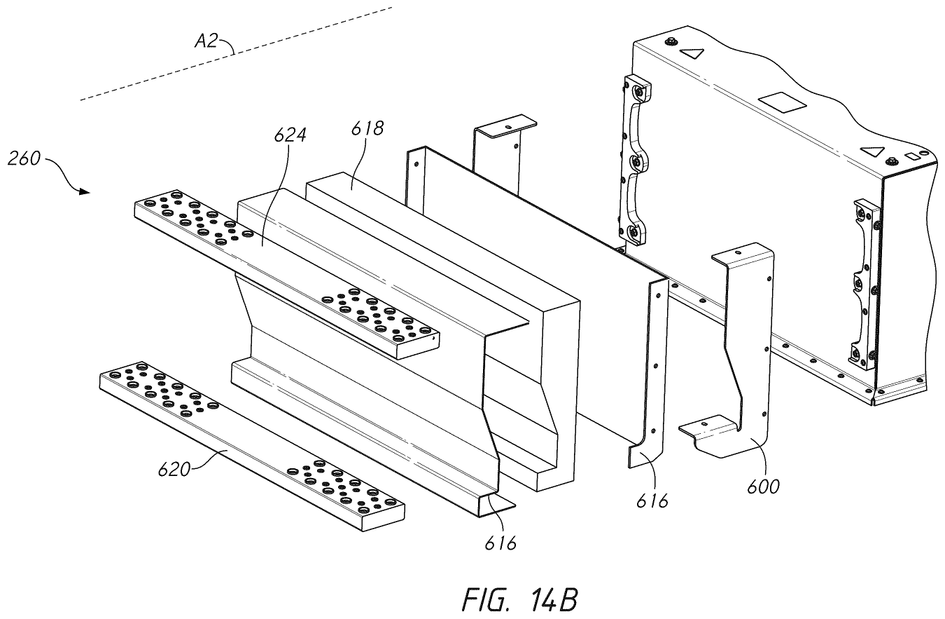

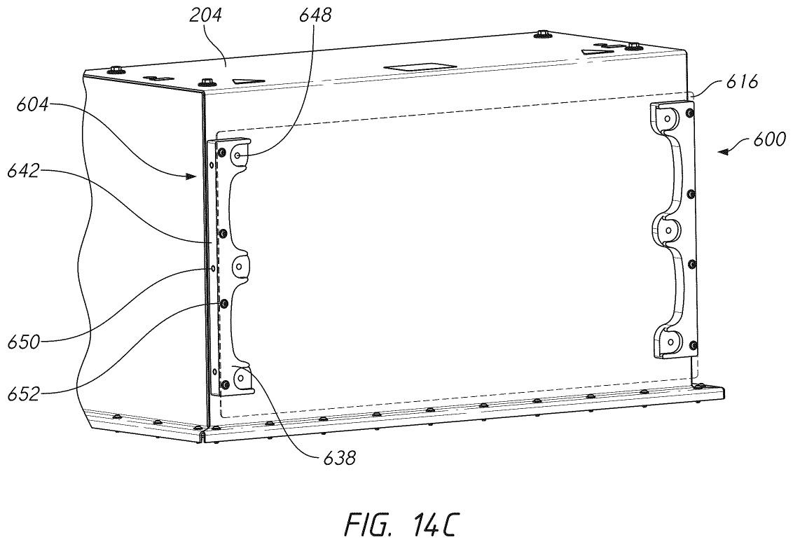

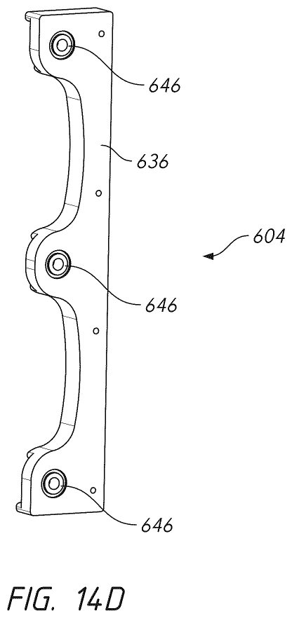

FIG. 14 illustrates a side perspective view of a charge inlet assembly 1400 attached to the battery assembly 100. The battery assembly 100 can include a housing 200 that encloses one or more battery units therein. The charge inlet assembly 1400 can be disposed adjacent to the housing 200. While the charge inlet assembly 1400 is shown as being forward of the housing 200, in other embodiments, the charge inlet assembly 1400 may be rearward (i.e., closer to the rear of the vehicle) of the housing 200. However, in any configuration, the charge inlet assembly 1400 may not obstruct the ability to attach vehicle bodies or other systems to the frame rails of the vehicle.

The battery assembly 100 can include a step assembly 260. A lower and an upper step can be integrated into the step assembly that is supported by the housing 200 of the battery assembly 100 to enable battery units in the battery assembly 100 and the step assembly 260 to be simultaneously attached to the vehicle frame.

FIGS. 14A and 14B illustrate the step assembly 260 both separated from the enclosure 500 and in an exploded view format, respectively. The step assembly 260 can include a step mounting bracket assembly 600 on an outboard side of the housing 200. For example, the step assembly 260 can be mounted to a lateral side of the housing 200. The step assembly 260 can be mounted on both sides of the housing 200, e.g., on both lateral sides.

The step assembly 260 can be an assembly including a vehicle side 612 that is configured to be coupled with the housing 200. The vehicle side 612 can also be an inboard side. The step assembly 260 can include a lateral side 614 located on the opposite side from the vehicle side 612. The lateral side 614 can be an outboard side of the step assembly 260. The vehicle side 612 of the step assembly 260 can be configured to mate to the step mounting bracket assembly 600 as discussed further below. The step assembly 260 can include a lower step 620 and an upper step 624. The lower step 620 can be disposed on the lateral side 614 of the step assembly 260. The upper step 624 can be disposed on the lateral or a top side of the step assembly 260. The upper step 624 can be disposed at an elevation above an elevation of the lower step 620. The position of the upper step 624 along the direction of the longitudinal axis A2 can be inboard compared to the position of the lower step 620 such that a natural or comfortable step distance can be provided therebetween. One or both of the lower step 620 and the upper step 624 can include roughened areas that have enhanced traction, as shown.

The step assembly 260 can include an enclosure 616 enclosing a space therein, the enclosure 616 configured to be coupled with the step mounting bracket assembly 600. The step assembly 260 can include one or more impact features. For example, the enclosure 616 can enclose a crumple member 618 disposed therein. The crumple member 618 can be configured to collapse upon application of a load of a certain type. For example, a side impact can cause the crumple member 618 to absorb at least some of the energy of the impact by being crushed or collapsing upon itself. In one embodiment, the crumple member 618 includes a honeycomb structure that has high strength in some directions, e.g., in a vertical direction. The crumple member 618 can be creased, pre-crumped, or non-uniformly weakened to some extent such that the collapse of the structure is predictable or planned or is in a manner that is preferred. In some embodiments, the crumple member 618 or other impact feature extends laterally of a charge inlet assembly 1400 such that impact energy can be dissipated in the more lateral structure than that of the charge inlet assembly 1400. The honeycomb structure can be aligned in a vertical direction. For example, the longitudinal axes of the honeycomb structures can be aligned with the vertical direction. The honeycomb structures will collapse inwardly or transverse to the longitudinal axes thereof upon a side load above a threshold consistent with a side impact.

FIG. 14C shows more detail of how the step assembly 260 is mounted to the first lateral portion 204 of the battery assembly 100. The step mounting bracket assembly 600 can have a multi-point load spreading member 604 that is configured to receive and transfer a standard step loading and a side impact loading to the housing 200 in a planned manner. The multi-point load spreading member 604 is configured to provide significant load support on the housing 200 while at the same time preserving or maintaining ingress protection. The multi-point load spreading member 604 can include a first side 636 for mating with the housing 200. The multi-point load spreading member 604 can include a second side 638 opposite to the first side 636. The second side 638 can be configured to mate the multi-point load spreading member 604 to an enclosure of the housing 200. The second side 638 can be configured to receive a first step support fastener aperture 650 to support a load of the step assembly 260. The multi-point load spreading member 604 can include a third side 642 between the first side 636 and the second side 638. The third side 642 can be configured to receive a second step support fastener aperture 652. The second step support fastener aperture 652 can transfer a portion of the load of the step assembly 260 to the multi-point load spreading member 604 and thereby to a frame member of the battery assembly 100.

FIG. 14D shows the multi-point load spreading member 604 in further detail. The multi-point load spreading member 604 includes a plurality of, e.g., three seal member channels 646. Each seal member channel 646 can be configured to receive a seal member. The seal members in the seal member channel 646 provides ingress protection between the first side 636 of the multi-point load spreading member 604 and the side surface of an enclosure of the housing 200.

The multi-point load spreading member 604 provides a feature that is attached to but is not otherwise fluidly connected to the interior of the enclosure of the housing 200. As a result, providing many apertures, such as the first step support fastener aperture 650 and the second step support fastener aperture 652 in the multi-point load spreading member 604 does not increase the risk of ingress of moisture into the interior of the enclosure 500 of the housing 200.

FIG. 14C shows that the step assembly 260 can be mounted to the multi-point load spreading member 604 seven points. The illustrated embodiment provides two multi-point load spreading member 604, one for a front and one for a rear part of the step assembly 260. Each of the multi-point load spreading member 604 can be coupled to the step assembly 260 at a plurality of points on the second side 638 (e.g., four points on the second side 638) and another plurality of points on the third side 642 (e.g., three points). The step assembly 260 can be coupled with the step mounting bracket assembly 600 at seven points. In an assembly with a step mounting bracket assembly 600 at opposite ends of the step assembly 260, there can be fourteen points of connection compared to six structural mounts to the housing 200. This arrangement is one example of how the load can be spread to more than twice as many spots on the housing 200 as the number of locations that the two multi-point load spreading members 604 are mounted to the housing 200.

The step assembly 260 thus provides for extensive load support in a stepping application. A honeycomb or similar configuration of the crumple member 618 or other impact feature(s) help or helps support the vertical load typical of stepping. The step assembly 260 also is pre-configured to absorb a side impact load and thereby to dissipate some of the energy of the side impact. A portion of the load of a side impact is transferred through the battery assembly 100 to the frame assembly 46 or 86 of the vehicle assembly 40 or 80.

The charge inlet assembly 1400 may be integrated into the step assembly 260. In some embodiments, an aperture of the step assembly 260 accommodates the charge inlet of the charge inlet assembly 1400. The step assembly 260 may be wider than the step assembly 260 of FIGS. 14A and 14B, as the step assembly 260 of FIG. 14 spans the longitudinal length of the housing 200 as well as the longitudinal length of the charge inlet assembly 1400.

Conventional charge inlets may be located rearward of the housing 200 and may project outward beyond the step assembly 260. These conventional charge inlets being located beyond the step assembly 260 may cause interference with vehicle body designs that occupy the space beyond the step assembly 260. For example, some vehicle body designs project downward and adjacent to the rear of the housing 200, and if the conventional charge inlet is located in that space, these vehicle body designs may not be implemented.

In comparison, the charge inlet assembly 1400 is not located in a location that prevents or limits the types of vehicle body designs that may be attached to the vehicle frame. In addition, the location of the charge inlet assembly 1400 allows for shorter charge cables to be used, as the charge inlet assembly 1400 is located closer to the front of the vehicle. Also, as can be seen in FIG. 14, the charge inlet assembly 1400 is located underneath (or in proximity to) the door hinge of the cab, which results in the charge inlet assembly 1400 being out of the way of a driver entering and exiting the vehicle or individuals servicing the vehicle. The charge inlet assembly 1400 being integrated with the housing 200 and the step assembly 260 also reduces labor associated with fabricating the combined assembly.

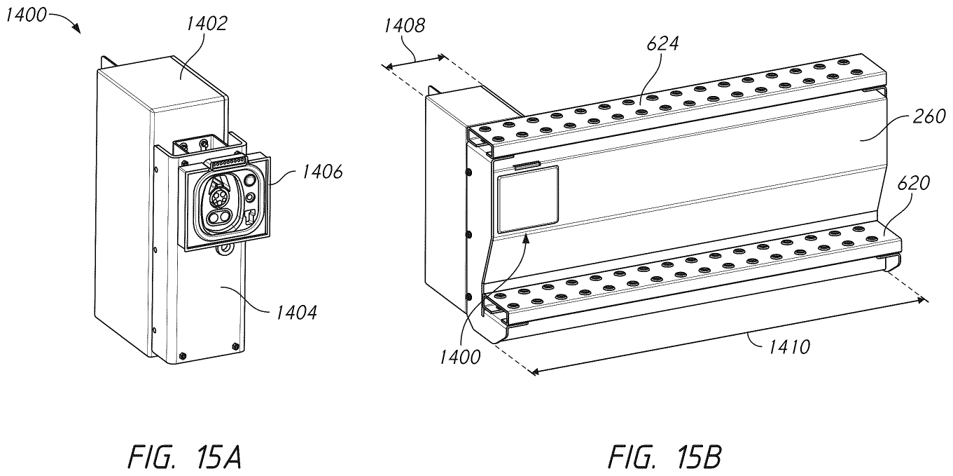

FIG. 15A illustrates the portion of the charge inlet assembly 1400 behind (or closer to a longitudinal axis of the vehicle relative to) the step assembly 260. The charge inlet assembly 1400 includes a charge inlet housing 1402 that is coupled to the housing 200. The charge inlet assembly 1400 also includes a step extension bracket 1404 coupled to the charge inlet housing 1402, as well as a receptacle 1406 coupled to the step extension bracket 1404. The step extension bracket 1404 occupies a cavity within the step assembly 260 and allows the receptacle 1406 to be flush with a front face of the step assembly 260. Although the receptacle 1406 can be flush with a front face of the step assembly 260 certain components of the charge inlet assembly 1400 can be recessed into the receptacle 1406, e.g., disposed medially of the lateral face of the step assembly 260 such that an impact feature, such as the crumple member 618 can absorb a side impact, dissipating the energy of the impact before the recessed components are affected.

FIG. 15B illustrates the charge inlet assembly 1400 and the step assembly 260. FIG. 15B also shows an upper step 624 and a lower step 620 coupled to the step assembly 260, as described herein. The charge inlet housing 1402 has a longitudinal length 1408. The step assembly 260 has a longitudinal length 1410. The longitudinal length 1410 is longer than a longitudinal length of the housing 200, and in some embodiments, the longitudinal length 1408 and the longitudinal length of the housing 200 corresponds to the longitudinal length 1410. Impact protection features of the step assembly 260 described herein may also protect the charge inlet assembly 1400, along with the battery assembly 100.

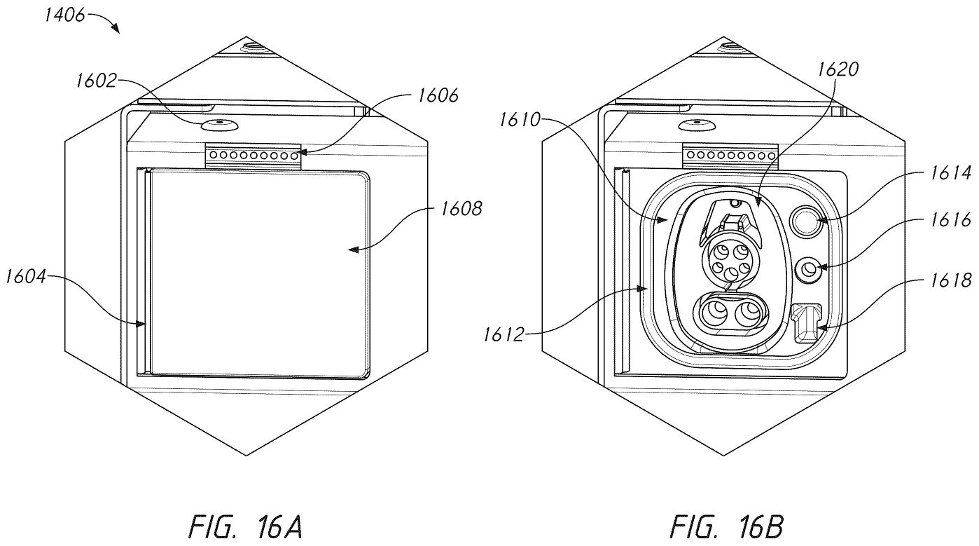

FIG. 16A illustrates the receptacle 1406 accessible by moving a cover (or door) 1608 about a hinge 1604. The cover 1608 is shown in the closed position. FIG. 16B illustrates the receptacle 1406 with the cover 1604 removed for clarity. When the cover 1608 is in the open position (e.g., rotated forwardly about the hinge 1604), the charge inlet 1620 is exposed, and a charge plug may be attached (or coupled or mated or connected) to the charge inlet 1620. The charge inlet 1620 receives electrical charge from the charge plug to recharge the battery. The charge plug may provide charge in AC or DC. While the charge plug is attached to the charge inlet 1620, a handle lock may automatically engage, as a safety measure, to prevent exposure to high voltage from the charge plug.

Adjacent to the receptacle 1406, located on a surface of the step assembly 260, is a manual release 1602 for a combined charging system (CCS) lock. The manual release 1602 may be an access hole for manually releasing the lock engaged by the charger handle of the charging plug. In some embodiments, the manual release may only be engaged when no current is flowing from the charge plug to the charge inlet. Adjacent to the charge inlet 1620 is a button 1614 to initiate shutdown of charge. When the button 1614 is engaged, current may stop flowing from the charge plug. In some embodiments, when the button 1614 is engaged, the lock of the charger handle may automatically disengage.

Also adjacent to the receptacle 1406 are one or more lights 1606 indicating a charge status of the batteries. The charge status may be reflected by one or more colors of lights (e.g., green for fully charged, red for charging) and/or one or more light patterns (e.g., flashing lights to indicate charging, solid lights to indicate fully charged).

The door 1608 may be attached by a hinge 1604. In some embodiments, the door 1608 opens by pushing to open or close. In some embodiments, the door 1608 opens by engaging a button within the vehicle cab. In some embodiments, the door 1608 is locked and can be opened using a key or passcode. A latch to keep the door 1608 closed may be received by a latch receptacle 1616. The receptacle 1406 may also include a cavity 1618 for a door sensor actuator configured to detect when the door 1608 is closed.

The receptacle 1406 includes an insert 1610 to cover connector hardware located beneath, and the receptacle 1406 has a gasket 1612 surrounding a perimeter, to seal the receptacle 1406 from ingress of moisture and debris when the door 1608 is closed.

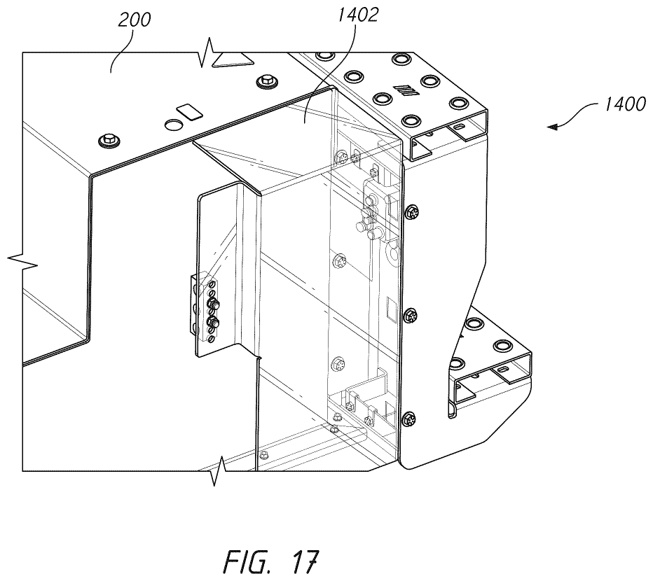

FIG. 17 illustrates a rear view of the charge inlet assembly 1400, showing the coupling of the charge inlet housing 1402 to the housing 200. Once the charge inlet 1620 receives electrical charge from the charge plug, the electrical charge is delivered to the batteries within the housing 200. High voltage connectors connect the charge inlet 1620 to the batteries of the housing 200.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A power distribution assembly for a vehicle, comprising:
a power distribution unit comprising:
a housing;
a cable junction disposed on an exterior of the housing;
one or more fuses disposed in the housing configured to interrupt current flow through the power distribution unit;
a contactor disposed in the housing and configured to interrupt a current flow from the power distribution unit to a load; and
a charge circuit disposed in the housing and configured to direct current from a DC power source to a vehicle battery assembly, the charge circuit comprising one or more fuses and one or more contactors configured to interrupt a current flow from the DC power source to the vehicle battery assembly; and
a mounting system configured to couple and suspend the power distribution unit from frame rails of the vehicle.

2. The power distribution assembly of claim 1, wherein the charge circuit is a first charge circuit and further comprising a second charge circuit disposed in the housing configured to receive current from an AC power source and to direct the current flow to a vehicle battery.

3. The power distribution assembly of claim 1 wherein the mounting system comprises a frame rail interface disposed along lateral sides of the power distribution assembly, an upper tray, and a cable strain relief module on a forward facing side of the power distribution assembly, the cable strain relief module configured to reduce strain in a high voltage cable coupled with the power distribution unit.

4. The power distribution assembly of claim 3, wherein the cable junction of the power distribution unit is aligned with a cable management component of the cable strain relief module.

5. The power distribution assembly of claim 3, wherein the frame rail interface comprises a first bracket having a vertical portion configured to engage an inwardly facing surface of a first C-shaped frame rail and a horizontal portion configured to be disposed over a transverse surface of the first C-shaped frame rail and a second bracket configured to couple with a second C-shaped frame rail opposite the first C-shaped frame rail, the second bracket having a vertical portion configured to engage an inwardly facing surface of the second C-shaped frame rail and a horizontal portion configured to be disposed over a transverse surface of the second C-shaped frame rail.

6. The power distribution assembly of claim 5, wherein the upper tray is supported on a first lateral portion by the first bracket and on a second lateral portion by the second bracket, and further comprising a charge circuit supported on a lower side of the upper tray above the housing of the power distribution unit, the charge circuit configured to receive current from an AC power source and to direct the current to a vehicle battery to charge the vehicle battery.

7. The power distribution assembly of claim 6, further comprising a traction inverter coupled with an upper side of the upper tray, the traction inverter configured to be coupled to the cable junction to receive power from the power distribution unit and to be coupled with an electric motor to deliver current to the electric motor to apply torque to a vehicle axle.

8. The power distribution assembly of claim 7, further a powertrain control module configured to regulate the current flow through the traction inverter to an electric motor coupled with the power distribution assembly.

9. The power distribution assembly of claim 3, further comprising a debris deflector coupled with the frame rail interface along at least one of the lateral sides of the power distribution assembly, the debris deflector enclosing a bottom side and lateral sides of the power distribution unit and leaving unobstructed access for power cables to the cable junction.

10. A power distribution system comprising the power distribution assembly of claim 5, wherein the mounting system comprises a first mounting system and further comprising a second mounting system, the second mounting system comprising a second frame rail interface and a second upper tray, and further comprising a traction inverter coupled with an upper side of the second upper tray, a traction motor configured to be coupled to the cable junction by way of the cable strain relief module of the first mounting system to receive power from the power distribution unit and to be coupled with an electric motor to deliver current to the electric motor to apply torque to a vehicle axle.

11. The power distribution system of claim 10, further comprising a powertrain control module coupled with the second upper tray, the powertrain control module configured to regulate the current flow through the traction inverter to the electric motor coupled with the power distribution system.

12. The power distribution system of claim 10, further comprising a debris deflector coupled with the second mounting system, the debris deflector comprising a forward deflector panel and a rearward deflector panel.

13. The power distribution system of claim 12, further comprising a debris deflector being coupled with the first mounting system and enclosing a bottom side and lateral sides of the power distribution unit, the debris deflector being coupled with the first mounting system leaving unobstructed access for power cables to the cable junction.

14. The power distribution system of claim 10, further comprising a forward debris deflector coupled with the first mounting system and a rearward debris deflector coupled with the second mounting system, the forward debris deflector providing a first ground clearance and the rearward debris deflector providing a second ground clearance greater than the first ground clearance.

15. A vehicle assembly, comprising:
the power distribution assembly of claim 1; and
a battery assembly comprising:
a battery housing configured to house one or more battery units; and
a charge inlet assembly coupled to the battery housing, the charge inlet assembly including a charge inlet configured to receive electrical charge from a charge plug, and a charge inlet housing coupled to the battery housing,
wherein the charge inlet assembly is disposed on a forward facing side of the battery housing.

16. The vehicle assembly of claim 15, wherein the charge inlet assembly further comprises a door configured to cover and protect the charge inlet.

17. The vehicle assembly of claim 15, further comprising a step assembly having one or more steps and configured to span a longitudinal length of the charge inlet housing and the battery housing.

18. The vehicle assembly of claim 17, wherein the step assembly includes an aperture located on a face of the step assembly corresponding to a receptacle of the charge inlet assembly.

19. The vehicle assembly of claim 18, wherein the aperture of the step assembly is aligned with a door hinge of the vehicle.

20. The vehicle assembly of claim 18, wherein the step assembly includes one or more impact features configured to protect one or both of the battery housing and the charge inlet assembly from impact.

21. The vehicle assembly of claim 15, wherein the charge inlet assembly further comprises one or more charge status lights configured to indicate a charge status of the one or more battery units.

22. The power distribution assembly of claim 3,
wherein the housing includes an upper portion coupled with the frame rail interface and a lower portion disposed below the mounting system, the lower portion comprising an access panel.

23. The power distribution assembly of claim 22, wherein the upper tray is disposed over the power distribution unit and an AC charge circuit coupled with the upper tray above the power distribution unit.

24. (canceled)

25. (canceled)

26. A vehicle assembly, comprising:
a vehicle chassis comprising a longitudinal frame rail having a concave cross-section oriented toward a central vertical plane of the vehicle chassis such that a horizontal surface extends inwardly from a vertical surface of the longitudinal frame rail;
a battery pack coupled with the vehicle chassis and disposed at least partially below the longitudinal frame rail; and
a power distribution assembly, comprising:
a mounting system comprising a bracket having a vertical portion overlapping the vertical surface of the longitudinal frame rail and a horizontal portion resting on the horizontal surface of the longitudinal frame rail, the vertical surface and the horizontal surface comprising a clearance opening; and
a power distribution unit coupled with the mounting system, comprising:
a cable junction facing and disposed adjacent to a rear surface of the battery pack;
one or more fuses configured to interrupt current flow through the power distribution unit;
a contactor configured to interrupt a current flow from the power distribution unit to a load; and
a charge circuit configured to direct current from a DC power source to the battery pack, the charge circuit comprising one or more fuses and one or more contactors configured to interrupt a current flow from the DC power source to the battery pack;
wherein the mounting system further comprises a fastener disposed around the longitudinal frame rail, passing through the clearance opening to enclose the bracket and the longitudinal frame rail.

27. The vehicle assembly of claim 26, wherein the battery pack further comprises a charge inlet assembly coupled to a battery pack housing, the charge inlet assembly having a charge inlet configured to receive electrical charge plug.

28. The vehicle assembly of claim 27, wherein the charge inlet assembly is disposed between a forward facing side of the battery pack and a front of the vehicle assembly.

29. The vehicle assembly of claim 27, wherein the charge inlet assembly further comprises a door configured to cover and protect the charge inlet.

30. The vehicle assembly of claim 27, wherein the battery pack further comprises a step assembly having one or more steps and configured to span at least a portion of a lateral edge of a charge inlet housing and the battery pack housing.
